(19) United States
(12) Patent Application Publication
(10) Pub. No.: US 2026/0023738 A1
(43) Pub. Date: Jan. 22, 2026

(54) DETECTING AND REMEDIATING DATA GAPS IN RESOURCE MANAGEMENT SYSTEMS

(71) Applicant: Direct Supply, Inc., Milwaukee, WI (US)

(72) Inventors: Suzanne Lieven, Cedarburg, WI (US); Timothy Lee Ernst, Grafton, WI (US); William Schreiner, Greenfield, WI (US)

(21) Appl. No.: 19/270,405

(22) Filed: Jul. 15, 2025

Related U.S. Application Data
(60) Provisional application No. 63/671,980, filed on Jul. 16, 2024.

(51) Int. Cl. G06F 16/23

(52) U.S. Cl. CPC G06F 16/2365

(57) ABSTRACT

The disclosed technology includes systems and methods for addressing data gaps in fragmented data collections generated by discontiguous networks comprising multiple systems distributed across digital and physical locations. They include composing a record of a resource by matching identifiers across one or more data sources. A model is used to identify data gaps in the record by comparing first values of first attributes against a reference comprising second attributes and second values retrieved from the data sources. Each data gap includes a nonconforming attribute with an invalid value and a fault type. The system generates a request to resolve the data gap by correcting the invalid value of the nonconforming attribute according to the identified fault type.

### CROSS-REFERENCE TO RELATED APPLICATIONS

This application claims priority to and the benefit of U.S. Provisional Patent Application No. 63/671,980, filed Jul. 16, 2024, entitled “Systems, Methods, and Media for Managing Facility Assets Through Dynamic User Prompts,” the entire contents of which are incorporated herein by reference.

### BACKGROUND

Maintaining accurate records presents significant challenges in resource management when collecting fragmented data across discontiguous networks of digital and physical systems (e.g., in facilities management, particularly in senior living and healthcare environments). Traditional resource management approaches often struggle with data gaps, including missing, duplicate, stale, anomalous, and unverified information about critical resources. These gaps frequently result from data being dispersed across multiple systems with varying data models, collection methods, and update frequencies. When maintenance staff, service providers, and administrators interact with these fragmented systems, for example, they often lack visibility into which resource attributes are invalid or missing, preventing effective prioritization based on resource criticality or failure risk.

### BRIEF DESCRIPTION OF THE DRAWINGS

Various objects, features, and advantages of the disclosure can be more fully appreciated with reference to the following detailed description of the disclosure when considered in connection with the following drawings, in which like reference numerals identify like elements.

FIG. 1 illustrates a flowchart depicting a data compliance process implemented by a resource management framework, according to aspects of the present disclosure.

FIG. 2 illustrates a flowchart depicting for improving resource data compliance and integrity, in accordance with example implementations.

FIG. 3 illustrates a system diagram of a resource management framework, in accordance with some aspects of the disclosure.

FIG. 4 illustrates a system architecture for an AI-driven resource management platform of the example system of FIG. 3, in accordance with some aspects of the disclosure.

FIG. 5 illustrates a flowchart depicting an example resolution pattern for addressing data gaps, in accordance with some aspects of the disclosure.

FIG. 6 illustrates a flowchart depicting an example resolution pattern for addressing a data gap created by a product purchased event, in accordance with some aspects of the disclosure.

FIG. 7 illustrates a flowchart depicting an example resource audit resolution pattern, in accordance with some aspects of the disclosure.

FIG. 8 illustrates a flowchart depicting an example resolution pattern for preventive maintenance and event handling, in accordance with some aspects of the disclosure.

FIG. 9 illustrates an example user interface for managing resource data.

FIG. 10 illustrates an example interface for a site visit service displaying a checklist of standard items to assess during a facility inspection.

FIG. 11 illustrates an example user interface for a site visit service displaying an input log for addressing data gaps.

FIG. 12 illustrates an example user interface for a request for a service provider tool.

FIG. 13 illustrates an example user interface for a request for a resource compliance process based on dynamic composite location data.

FIG. 14 illustrates an example user interface for configuring expected attributes and recommended values for a resource reference.

FIG. 15 illustrates an example user interface for a request generated for a service that includes a capital planning tool.

FIG. 16 illustrates an example user interface of a dashboard including resource data gaps associated with a particular category and a location.

FIG. 17 illustrates an example user interface of a request for a reactive maintenance service.

FIG. 18 illustrates an example user interface of a request for a unit turn service.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology includes resource management systems and methods for detecting and remediating data gaps in such systems. Resource management systems include comprehensive digital platforms designed for managing, tracking, and optimizing the use and status of physical and digital resources across discontiguous networks. As used herein, the term “discontiguous” can refer broadly to any arrangement in which elements, nodes, or components are not necessarily adjacent, sequential, or directly connected in any physical, logical, organizational, temporal, or functional sense. Discontiguity can manifest as separation in geography, corporate ownership, memory location, time, function, or communication path, including but not limited to elements located in different places, under different control, stored in non-adjacent memory, active at different times, or otherwise not directly or continuously connected. The term is intended to encompass any form of separation, discontinuity, or non-adjacency that may arise in the implementation or operation of the processes, networks, or system described herein. These resources can include assets, such as physical assets and facility infrastructure, consumable and maintenance resources, information and data assets, human resources and service providers, networked and cyber assets, or regulatory, compliance, and legal assets. Such systems can oversee the lifecycle, compliance, and operational status of assets within an organization-such as in senior living facilities, enterprise campuses, or large distributed infrastructures.

In modern technology ecosystems, organizations increasingly depend on diverse collections of digital and physical assets that are distributed across discontiguous networks, creating significant challenges for maintaining integrity and completeness in asset data. One of the predominant technical issues in such environments is the prevalence of incomplete, fragmented, or outdated data that results from differences in how, when, and where data is collected among various systems. When assets are spread across multiple physical locations or isolated network segments, the data they generate is often inconsistent and replete with gaps. These data deficiencies not only reduce confidence in the accuracy of asset records but also undermine the reliability of any analytics or automation processes built upon this data. As a consequence, organizations are frequently forced to rely on manual interventions to fill these data gaps-methods that are inefficient, error-prone, and unable to respond quickly to evolving data states.

When outdated or incomplete data propagates into central hubs or downstream systems, it creates additional technical inefficiencies. These downstream systems are left to process suboptimal information, which can lead to poor decision-making, maintenance delays, and missed opportunities for operational optimization. Further, inaccurate asset inventories significantly elevate cybersecurity risks: unpatched or misidentified systems are more vulnerable to attacks, and the delay in identifying or correcting gaps can leave critical infrastructure exposed. Stale or erroneous asset data can also impact the organization's ability to allocate resources effectively, hampering both day-to-day operations and long-term planning. Ultimately, these technical failures manifest as increased operational costs, greater risk of unplanned equipment failures, and diminished agility in responding to emergent threats or requirements.

Implementations of the disclosed technology address these technical limitations and more through methods and systems that detect, characterize, and remediate data gaps in fragmented records. These data gaps can include missing or expected attributes within records, as well as entirely missing asset records themselves. For example, the disclosed systems compose a comprehensive and unified record for each resource, intelligently matching identification values (e.g., IDs) across disparate data sources. Once records are composed, the system retrieves references with expected attributes and recommended values, and inputs both actual and recommended attribute values into an advanced ensemble model trained to determine which attributes are nonconforming or are associated with invalid values. This approach then uses a data prioritization model to prioritize remediation efforts, factoring in a resource impact score, a resource failure risk, and an anticipated gain from correction.

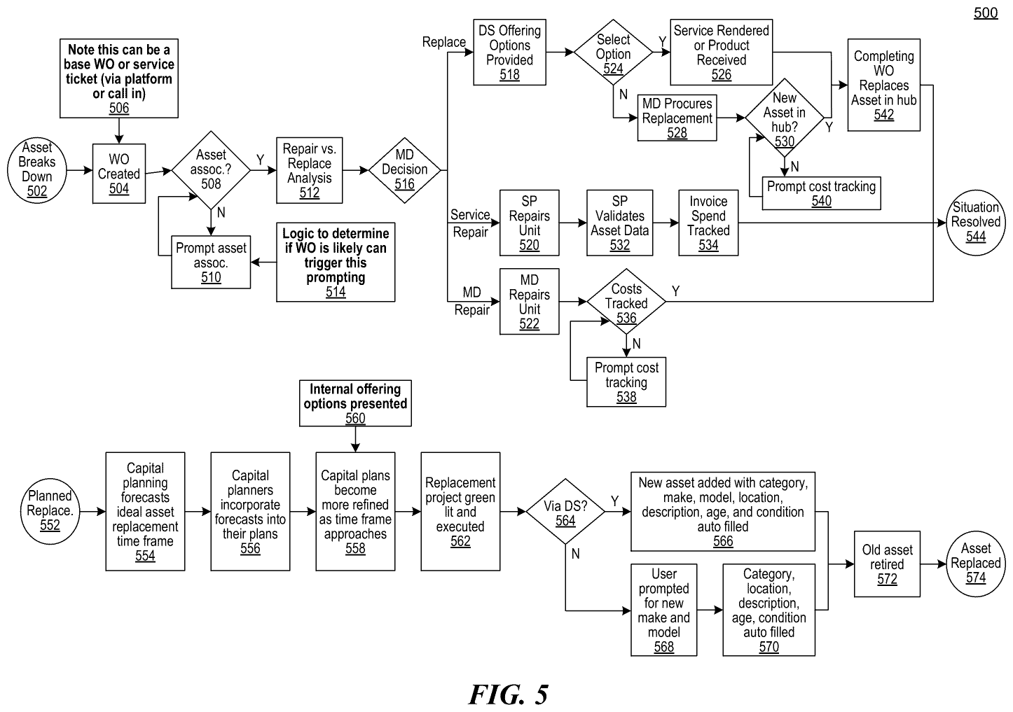

For each high-priority data gap, a resource association model can associate resolution patterns and corrective actions; also, the model can link these actions to event-based triggering conditions. A resolution pattern can include one or more of a series of workflows, illustrated by FIGS. 5, 6, 7, and 8, and can include a series of steps and decisions points that can be implemented by a service, as described herein, or as described generally.

When an event occurs that satisfies such a condition, the system can automatically generate a request for remediation, tailored to the available corrective capabilities of target services. This allows an invalid value of the data gap to be replaced with a correct one, restoring the integrity of the record and safeguarding downstream systems from the consequences of poor data quality. A value is an “invalid value” according to a deviation from its corresponding recommended value according to a reference for that resource. This includes values that are missing, duplicative, out-of-date, unverified, or anomalous. Consequently, whether a value is invalid or acceptable can change depending on changes to the underlying recommended values, or depending on changes to the expected attributes associated with the recommended values, or depending on changes to the overall reference for the resource as a whole, which contains both the expected attributes and the recommended values and as a basis for comparison for the record of known attributes with actual values that describe the resource in the plurality of data sources. These changes can be the result of inputs from a user with administrative permissions to the resource management system, or they can be the result of statistical drift, which can manifest in changes to the outputs of different models described herein.

A reference for a resource can include a corporate configuration, a template, a data structure, or a set of rules that define the expected attributes and recommended values for that resource. The reference can be defined according industry standards, regulatory requirements, manufacturer specifications, organizational policies, or by best practices relevant to the resource type. In some implementations, the reference can be dynamically generated or updated based on historical data, predictive analytics, or user input. The reference can include mappings to external data sources, versioning information, and metadata describing the provenance and validity intervals of the recommended values. References can encode conditional logic or dependencies between attributes, such as specifying that the expected value for one attribute is contingent on the value of another attribute, or that certain attributes are required only under specific operational scenarios. In some implementations, the reference can be instantiated as a machine-readable schema, ontology, or configuration file, enabling automated comparison and validation of resource data across heterogeneous systems of the discontiguous network.

A value can be considered an “invalid value” when it deviates from a corresponding recommended value specified in a reference for that resource. Whether a value is invalid or acceptable can change over time, depending on updates to the recommended values, changes to the expected attributes, or revisions to the overall reference for the resource. The reference may include both the expected attributes and the recommended values, and it serves as the basis for comparing actual recorded values from various data sources. These changes can result from manual updates by users with administrative permissions or from automated adjustments, such as those caused by statistical drift in machine learning models.

An invalid value can occur in several ways. For example, if a generator resource possesses a reference with an expected attribute of an operating temperature with a recommended value of between 60 and 80 degrees Celsius, a record of the generator resource with an actual value outside this range would be invalid (e.g., an invalid value with a fault type that is “anomalous data”). In addition, a record of the generator resource that is missing the operating temperature attribute entirely would also be a nonconforming attribute with an invalid value (e.g., an invalid value with a fault type that is “missing data”). If the set of required attributes for a resource changes-such as adding a new “leakage rate” for water pipes-then missing values for this new attribute can make existing records invalid. Similarly, if the recommended values are updated, such as lowering the maximum pressure for a storage tank, values that were once valid may become invalid. In systems that use statistical models, changes in data patterns can also lead to updates in recommended values, which may affect the validity of existing data. Administrators can also update references manually, for example, after equipment upgrades or regulatory changes.

For instance, a hospital's HVAC system may require humidity to be between 40% and 60%. If a sensor reports 65%, this value is invalid according to the current standard. If the standard later changes to allow 65%, the same value becomes valid. In another example, a fleet management system may require tire pressure to be 35 psi, so a reported value of 28 psi is invalid-unless the manufacturer later updates the recommendation to 28 psi. Similarly, if a transformer record is missing a now-required “installation date,” the record is invalid until the missing information is provided.

By transforming asset data remediation from a reactive, manual task into an automated, intelligent, and context-aware process, the disclosed technology delivers pronounced technical improvements by enhancing the accuracy and timeliness of records, reducing cybersecurity vulnerabilities, optimizing operational decision-making, and supporting more agile and resilient infrastructure management.

The disclosed technology provides a platform for asset compliance by unifying configuration, data collection, validation, and management of asset records. Corporate administrators can set customized asset configurations and standards-including required data fields, expected asset types and quantities, facility metadata, and lifecycle rules (such as useful life expectations and maintenance strategies)—to ensure consistency and regulatory alignment across all facilities and systems.

Implementations of the system feature asset data loading capabilities that include integrating asset information from multiple sources, including direct user input, service provider integrations, and third-party systems, and supports crowdsourcing and human validation workflows. A workflow can include any sequence, arrangement, or set of steps, actions, operations, or processes-whether manual, automated, or a combination thereof-performed by one or more users, systems, devices, or components to achieve a particular objective or result. A workflow can encompass, but is not limited to, the initiation, execution, monitoring, modification, or completion of tasks, activities, or procedures. A workflow can be implemented in software, hardware, or a combination of both, and can be executed locally, remotely, or in a distributed manner across multiple systems or locations. The steps or actions within a workflow can be performed in a predetermined order, in parallel, conditionally, or in response to events or triggers. A workflow can involve the processing, transfer, or transformation of data, the interaction between users and systems, or the coordination of resources, approvals, or notifications. In some implementations, a workflow can be defined by a set of rules, templates, scripts, or logic that governs the flow of information or actions. A workflow can be static or dynamic, and can be adapted or modified in real time based on user input, system state, or external factors. The term “workflow” is not limited to any particular industry, application, or technology, and can include, for example, business processes, manufacturing operations, software development pipelines, compliance procedures, maintenance routines, or any other organized set of activities.

This data is continuously evaluated for criticality and completeness; missing fields automatically trigger the creation of tasks or work orders to fill in data gaps, either by assigning them to users in context (e.g., user location) or by pulling data directly from integrated sources.

With its dynamic data assessment modules, the system can identify missing, out-of-date, or incorrect asset information. Advanced prioritization logic can filter and order data gaps by risk, criticality, and expected benefit of remediation. Real-time monitoring can ensure prompt detection of data changes (e.g., new assets, or repairs to assets), and also can allow for quick differentiation between repair and replacement needs, and can automatically associate new tasks or work orders with the relevant assets to improve workflow efficiency.

The disclosed technology also includes support for advanced forecasting and planning functions, leveraging complete and accurate data to enable proactive equipment management, capital planning, and predictive maintenance. By addressing data incompleteness, the disclosed forecasting models produce more reliable capital plans and recommend timely action, instead of merely presenting data gaps as static lists.

The disclosed technology can include a resource management framework designed to address the unique operational and fiscal challenges faced by owners and operators of managed properties, including any facility or real estate asset that requires systematic oversight, maintenance, and operational management of its resources (e.g., senior living facilities, campus housing, vacation rentals, data centers, libraries, archives, office buildings, apartment complexes, distribution centers, detention facilities, amusement parks, religious retreats, transportation terminals, or parking structures). The systematic collection and maintenance of high-quality asset data enables proactive resource compliance, equipment forecasting, and capital planning. The resource compliance component ensures the collection, evaluation, and ongoing quality of resource data, incorporating mechanisms to identify and prioritize gaps in resource management information. It integrates with existing user workflows and uses dynamic prompts to address data deficiencies, thereby improving compliance and operational efficiency. Building on this foundation, the equipment forecasting component analyzes resource data to project future equipment needs and costs, providing actionable recommendations for timely maintenance and replacement decisions. Finally, the capital planning component combines insights from equipment forecasting with budgetary considerations, enabling organizations to systematically plan and track capital expenditures across multiple facilities.

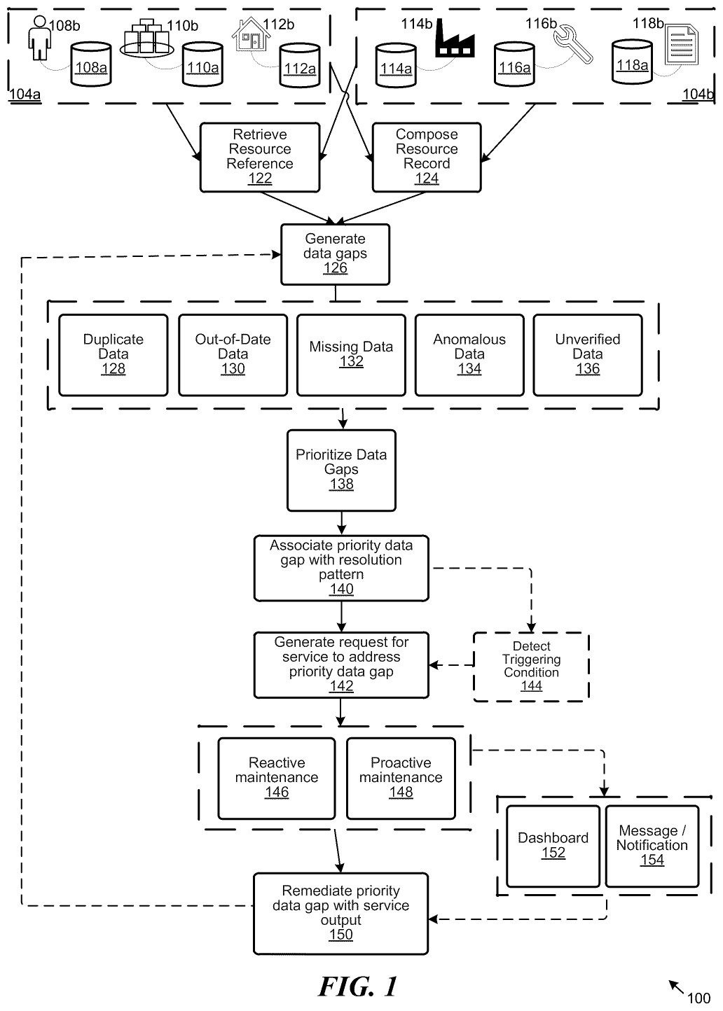

FIG. 1 illustrates a flowchart depicting a data compliance process 100 implemented by a resource management framework, according to aspects of the present disclosure. The process 100 addresses data gaps in a fragmented data collection produced by a discontiguous network including one or more systems 104a and 104b (e.g., facility management systems, enterprise asset management systems, smart infrastructure systems, resource management systems, digital twin platforms, organizational consortia, distributed enterprises, or hybrid cloud/on-premises IT). The one or more systems 104 and 104b are dispersed across digital locations 108a, 110a, 112a, 114a, 116a, and 118a, and physical locations 108b, 110b, 112b, 114b, 116b, and 118b.

The digital locations 108a-118a can include a plurality of data sources (e.g., a building management system, a maintenance management software, a financial/accounting system, an inventory management system, a vendor and warranty database, a sensor network of IoT devices, a regulatory compliance database, a user input/manual entry database, and/or an external benchmarking service of industry data for comparing resource performance, costs, or lifecycles). The physical locations 108b-118b can include any one of the examples provided herein, not limited to managed properties. The plurality of data sources can be associated with the one or more of the physical locations 108b-118b of the first system 104a and/or the second system 104b. For example, each physical location can be equipped with a building management system (BMS) that monitors environmental controls, a computerized maintenance management system (CMMS) that tracks maintenance activities, and a sensor network of IoT devices that collects real-time data on equipment usage and performance. Additional data sources, such as a financial/accounting system, can be linked to the same physical location to provide information on capital expenditures and asset depreciation, while a regulatory compliance database can store inspection and certification records specific to that location. These data sources can be electronically associated with the respective physical location through unique identifiers or network connections, enabling the process 100 to aggregate, analyze, and correlate data from the data sources for each facility. In some implementations, external benchmarking services can also be associated with one or more physical locations to provide comparative industry data relevant to the resources or operations at those sites.

The process 100 can include an operation 124 of composing a record. A record can include tables or rows in a relational database, XML files in a non-relational database, data objects in an object-oriented database, or other data structures suitable for storing information associated with assets, activities, or events, and can also be stored on physical data storage media such as hard drives, solid-state drives, optical discs, or other tangible computer-readable media. The operation 124 can include generating, assembling, linking, or attaching known attributes that describe a resource that is associated with the discontiguous network. The resource can be an asset, e.g., physical equipment (e.g., any tangible, movable, or immovable items such as machinery, vehicles, computers, servers, manufacturing tools, laboratory instruments, office furniture, or other hardware assets), intangibles (e.g., non-physical items of value, such as intellectual property, including patents, trademarks, copyrights, trade secrets, as well as licenses, digital rights, goodwill, or proprietary methodologies), software (e.g., software applications, operating systems, middleware, firmware, or any executable code, whether installed locally, hosted on a server, or provided as a service (SaaS), including both proprietary and open-source software, as well as associated licenses and usage rights), accounts (e.g., bank accounts, credit accounts, investment portfolios, escrow accounts, trust accounts, or other monetary repositories, encompassing accounts held at financial institutions, digital wallets, payment processing accounts, and any other financial instruments or vehicles that represent or store monetary value, facilitate transactions, or are subject to financial management and oversight), or property (e.g., real property, including land, buildings, facilities, and personal property, including inventory, supplies, consumables, and both owned and leased property, as well as rights-of-use or access).

Physical assets and facility infrastructure can include building systems (e.g., HVAC, electrical, plumbing, elevators, or fire suppression), facility equipment (e.g., medical devices, IT hardware, communication systems, laundry, kitchens); furnishings and fixtures (e.g., furniture, built-in cabinetry, or lighting), external or grounds infrastructure (e.g., landscaping, signage, parking, or exterior lighting), or transport assets (e.g., vehicles, utility carts, or on-premises transportation). Consumable and maintenance resources can include consumable supplies (e.g., cleaning chemicals, paper products, light bulbs, or batteries), maintenance parts and spares (e.g., HVAC filters, belts, gaskets, or plumbing components), personal protective equipment or PPE (e.g., masks, gloves, or safety goggles), inventory items (e.g., janitorial supplies or replacement bulbs tracked for minimum stock levels), or usage-tracked materials (e.g., lubricants or fluids monitored for consumption rates and restocking alerts). Information and data assets can include structured digital records (e.g., asset databases, configuration files, or compliance logs), documented policies or workflow procedures (e.g., preventative maintenance schedules, staff operating manuals, or safety protocols), legal or warranty documents (e.g., insurance certificates, equipment warranties, or inspection reports), or real-time data streams (e.g., IoT sensor feeds, telematics data, or environmental monitoring inputs). Human resources and service providers can include personnel (e.g., employee or contractor rosters, certifications, or training histories), external vendors or contractors (e.g., third-party maintenance firms, service agreements, or vendor contact info), authorized service providers (e.g., emergency repair technicians, specialized inspectors, or compliance auditors), or workforce scheduling data (e.g., duty rosters or timekeeping records). Networked and cyber assets can include IT systems (e.g., servers, desktops, laptops, or network-attached storage), networking equipment (e.g., switches, routers, access points, or firewalls), connected operational technology (e.g., building automation controllers, remote sensors, or proprietary facility systems), cloud-hosted services (e.g., SaaS applications, secure data backups, or multi-site data synchronization endpoints), or cybersecurity platforms (e.g., intrusion detection systems, authentication gateways, or endpoint protection agents). Regulatory, compliance, and legal assets can include inspection certifications (e.g., health and safety inspection reports, elevator compliance documents, or fire system certifications), permits and regulatory filings (e.g., building permits, environmental discharge permits, or local code compliance paperwork), compliance logs (e.g., audit trails, preventive maintenance tracking, or regulatory status dashboards), or legal documentation (e.g., lease agreements, risk management documentation, or insurance records).

Known attributes can include asset data, such as inputs that provide comprehensive information regarding each asset. Asset data can include the location of the resource, as well as identifying details such as make, model, serial number, installation date, installation cost, replacement costs, repair history, repair costs, part information, failure records, warranty status, warranty issues, and the estimated useful life of the resource. In instances where the exact purchase date is not known, community users can specify an approximate age of the resource. The condition of the resource can also be recorded.

Additionally, asset data can include a risk category, such as those defined by the National Fire Protection Association (NFPA) Risk Assessment. For example, Category 1 can indicate that failure is likely to result in major injury or death; Category 2 can indicate that failure is likely to cause minor injury; Category 3 can indicate that failure is not likely to cause injury but can cause discomfort; and Category 4 can indicate that failure has no impact on patient care.

Images can also be included as part of the asset data. Such images can capture the asset itself, its nameplate, and its condition. In one implementation, a computer vision model, such as a convolutional neural network (CNN), is trained to recognize and classify assets based on their visual features. For example, CNNs can enable automated identification and classification of assets based on images captured of the asset. The process 100 can include receiving digital images of assets, which can be obtained using a mobile device, camera, or other imaging equipment during field inspections, inventory audits, or maintenance activities. Digital images of assets can be passively captured by cameras during other processes, for example by a service that includes a robotic platform (e.g., floor cleaning), a dedicated asset tracking robotic platform, a continuously monitoring video camera of an auditor during a site visit, or images captured of assets during or after performing work (e.g., repair, maintenance, inspection, condition assessment) related to the asset. Accordingly, a timeline of digital images of assets can be maintained and used to determine changes to an asset requiring manual inspection or maintenance (e.g., a condition assessment if damage is identified), or for data validation if an asset is determined to have been replaced or is determined to be missing. Similarly, this can be used to identify if an asset has been moved, disrupted, or otherwise causing a potential regulatory compliance data gap that requires addressing by staff (e.g., moving an asset that is identified as blocking an emergency exit).

In addition to the visual content, the process 100 can include the capture and association of relevant metadata with each image. This metadata can include, but is not limited to, the date and time the image was taken (e.g., as recorded in the image's EXIF data), the geographic location where the image was captured (e.g., GPS coordinates or a mapped address), the identity of the user or technician who captured the image (e.g., through authenticated user credentials), and information about the device used to take the image (such as the make and model of a smartphone or camera). Additional image properties, such as resolution, file format, and orientation, can also be recorded. The collection of such metadata enhances the traceability and reliability of the asset records, supporting compliance, auditing, and chain-of-custody requirements.

Upon receiving an image and/or the relevant metadata, the process 100 can include processing such visual data using a trained CNN model. The CNN is structured with multiple layers, including convolutional, pooling, and fully connected layers, which collectively extract and analyze hierarchical features from the input image. Initial layers of the CNN detect basic visual elements such as edges and textures, while deeper layers identify more complex patterns, including shapes, object parts, and distinguishing characteristics unique to specific asset types.

The CNN is trained on a dataset comprising labeled images of various assets, where each image is annotated with information such as asset type, make, model, and condition. Through this training process, the CNN learns to associate specific visual features with corresponding asset categories. When a new image is provided, the CNN outputs a classification result, indicating the most probable asset type, make, and model depicted in the image.

In some implementations, the system can employ object detection models based on CNN architectures, such as Faster R-CNN, YOLO, or SSD. These models can not only classify the asset but also localize it within the image by generating bounding boxes around detected objects. This enables such implementations to classify multiple assets within a single image, or to isolate specific components of such assets, such as a nameplate or serial number tag, for further processing (e.g., optical character recognition). The output from the CNN-based model can be integrated with other system components to automate asset record creation, update existing asset databases, or trigger additional workflows such as maintenance scheduling or compliance checks.

Additionally or alternatively, optical character recognition (OCR) techniques can be applied to extract textual information from images of nameplates or labels, such as serial numbers and manufacturer details. In some implementations, natural language processing (NLP) techniques can parse and structure language information extracted from captured images for later integration into the asset management database.

In some implementations, an artificial intelligence or machine learning model can be used to assess the condition of the equipment based on the captured images. The system can also use artificial intelligence (AI) or machine learning (ML) models to assess the condition of the asset depicted in the image. For example, a deep learning model can be trained on a dataset of labeled images that represent various asset conditions, such as “new,” “good,” “worn,” or “damaged.” By analyzing visual cues such as surface wear, rust, dents, or missing components, the model can automatically classify the asset's condition. In some implementations, statistical inference techniques or unsupervised learning methods, such as autoencoders or clustering algorithms, can be used to detect anomalies or deviations from expected asset appearance, thereby flagging potential issues for further inspection.

For example, a field technician can use a mobile application to photograph an industrial generator during a site visit. Upon capturing the image, the process 100 can automatically upload the image along with its associated metadata (e.g., the timestamp, GPS location, and device information). A trained CNN model can process the image to identify the generator as a specific brand and model, while an OCR engine extracts the serial number from the nameplate. The condition assessment model analyzes the image for signs of wear or damage and classifies the generator's condition accordingly. All extracted data, including the image, metadata, and AI-generated assessments, are then stored in the asset management database and linked to the corresponding asset record.

Asset data can further include records of inspections, such as in-house maintenance activities. These records can document the date of inspection, time spent, money spent, corrective actions taken, asset logs, and test results. Similarly, asset data can include records of contractor inspections and testing, which can also document the date, time spent, money spent, corrective actions, asset logs, and test results.

The operation 124 can include matching common identification (ID) values from the plurality of data sources associated with the one or more systems 104a and 104b. For example, asset data can be automatically obtained through integrations with external systems. A unique combination of attributes, such as area, make, model, and serial number, can be used to link external records to the correct resource. Some of these systems can automatically load asset data into the database. For example, assets purchased through a connected purchasing system can capture purchase date, known attributes of the resource (such as gas type or electrical characteristics), warranty information, and other relevant details. Alternatively, asset data for the organization or facility can be loaded from a database into the framework for the resource compliance process 100. In some implementations, users at a facility can input data directly into the resource management tool. The user can also manually link current or planned work, such as work orders or tasks, with associated assets. For example, for tasks including proactive testing, inspections, and maintenance, this linking can be performed within the task itself using the task management tool.

A resource platform can act as the primary hub for collecting asset data from various sources. Integrated systems can include purchasing or procurement systems, which can automatically load asset data when an asset is purchased through a connected system. The resource platform can automatically load asset data, repairs, and maintenance information for items addressed during unit turns. This system can also capture the condition of assets while performing a unit turn and can obtain information regarding useful life, common repairs, and maintenance of assets, such as assets that are replaced frequently. Additionally, the resource platform can infer the existence of a recently purchased asset when an asset of the same type is being retired, and accordingly recommend loading data for the new asset. Conversely, when a new asset of a particular type is purchased, the platform can infer the impending retirement of an existing asset of the same type and recommend loading data for the recently purchased asset.

Resident engagement technology systems can automatically load asset data, repairs, and maintenance information for created work orders. Nurse call systems can also automatically load asset data, repairs, and maintenance information for systems and created work orders. Connected equipment systems can automatically load asset data, repairs, and maintenance information for connected equipment. Service provider systems can automatically load asset data, repairs, and maintenance performed by technicians using connected technician technology.

Electronic health record (EHR) or electronic medical record (EMR) systems can be used to pull data relevant to estimating expected assets, such as the number of rooms. Asset criticality categorization information can be obtained from NFPA 99 guidelines, which is used in the assessment process.

The process 100 includes retrieving references for each resource or asset record from multiple data sources, automatically populating expected attribute fields with recommended values derived from historical data, corporate configurations, and industry standards. For example, when an asset is procured through an integrated purchasing platform, the system can automatically populate fields such as asset category, expected useful life, warranty information, and purchase date. If only partial data is available, the system can supplement expected values using a combination of industry best practices, facility-established standards, and reference data from similar assets within the database.

To further enhance the accuracy and relevance of asset records, the process 100 can incorporate a wide range of organizational and operational factors. Corporate configurations and standards define baseline requirements for asset types and categories, ensuring consistency across the enterprise. Financial needs and budgets influence asset selection, replacement timing, and maintenance strategies, while risk tolerance parameters guide whether assets are managed with a run-to-failure or proactive maintenance approach. The system can also account for replacement strategies by asset category, allowing it to recommend optimal replacement intervals or trigger points. Both run-to-failure and proactive maintenance policies can be configured for individual assets or entire facilities, depending on organizational preferences and operational requirements.

The process 100 can set expected assets and quantities for each facility, ensuring that every location maintains appropriate inventory levels. The recommendation of asset quantity or range can be determined by the model, which analyzes data from similar facilities and operational requirements. In making these determinations, the system can leverage data from comparable facilities, including electronic medical record (EMR) data such as the number of beds in healthcare settings, square footage, facility age, geographic location, and facility type. This comparative analysis enables the system to tailor recommendations to the specific context of each facility.

Additionally, the system can configure and track further asset requirements, such as warranty status, purchase date, and the results of condition assessments. All recommendations and populated fields are cross-referenced with industry standards to ensure compliance and alignment with best practices. By integrating these diverse data points and organizational policies, the process 100 enables automated, context-aware population of asset records, supporting more accurate lifecycle management, budgeting, and regulatory compliance across the enterprise.

In some implementations, operation 124 includes loading resource data associated with an organization or facility from a database into the resource compliance process 100. The resource data can include, but is not limited to, resource identifiers, resource types, operational parameters, maintenance history, and location information. The database can be a centralized or distributed data store, and the loading operation can be performed automatically at scheduled intervals or in response to a user-initiated command.

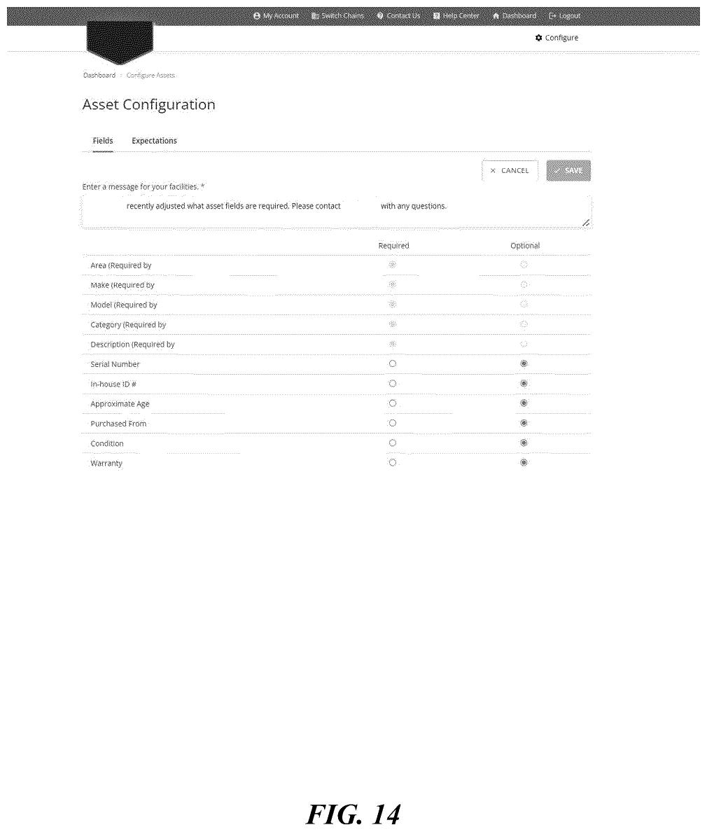

In addition to automated data loading, operation 124 can include enabling direct user input of asset data. As illustrated by FIG. 14, a user interface can allow users located at the facility, or otherwise authorized personnel, to input resource-related information directly into a resource management tool. This direct input can include the creation, modification, or deletion of asset records, as well as the entry of real-time operational data, inspection results, or compliance documentation.

The process 100 includes retrieving references for each resource or asset record from these multiple data sources in operation 122, automatically populating expected attribute fields with recommended values derived from historical data and standards. For example, an asset procured through an integrated purchasing platform can automatically have its category, expected useful life, and warranty information populated. If only partial data is available, the system can supplement expected values with industry best practices, facility-established standards, or reference data from similar assets within the database.

Additionally, the process 100 enables crowdsourcing of non-critical but valuable asset data, permitting users across different facilities or roles to upload or input documents and auxiliary information, such as manuals, specification sheets, or training materials. Crowdsourced data can serve as an important source for supplementing individual asset records, especially for supporting resources not automatically loaded via integrations. For example, a resource inference model can output an inferred resource attribute value, based on historical records of resources with similar attributes.

A resource inference model can be implemented using a variety of machine learning and statistical techniques to predict or estimate missing or uncertain resource attributes based on available data. In one approach, the model can use supervised learning algorithms, such as random forests, gradient boosting machines, or deep neural networks, trained on historical asset records where resource attributes (e.g., manufacturer, model number, maintenance interval) are known. The model learns correlations and patterns among asset features, enabling it to infer likely values for missing attributes in new or incomplete records. Alternatively, unsupervised learning methods, such as clustering or dimensionality reduction (e.g., k-means, principal component analysis), can be used to group assets with similar characteristics, allowing the system to impute missing values based on the most common attributes within a cluster. In some implementations, natural language processing (NLP) techniques can be applied to extract and infer resource attributes from unstructured crowdsourced documents, such as manuals or specification sheets, by identifying terms and contextual relationships. Bayesian inference models can also be employed to estimate attribute probabilities based on prior distributions and observed data, providing a measure of confidence in the inferred values. The resource inference model can be further enhanced by incorporating feedback loops, where user corrections or confirmations are used to retrain and refine the model over time, thereby improving accuracy and adaptability across diverse asset types and facilities. For certain asset attributes, human validation is required to confirm or fill data gaps. The process 100 can intelligently prompt users within their routine workflows-such as within work order creation, scheduled maintenance, or during facility walkthroughs—to review, enter, or correct specific asset details. For instance, when a maintenance user initiates a work order for a particular piece of equipment, the user interface can prompt for missing manufacturer or installation date, thereby enabling gap remediation during the performance of related tasks.

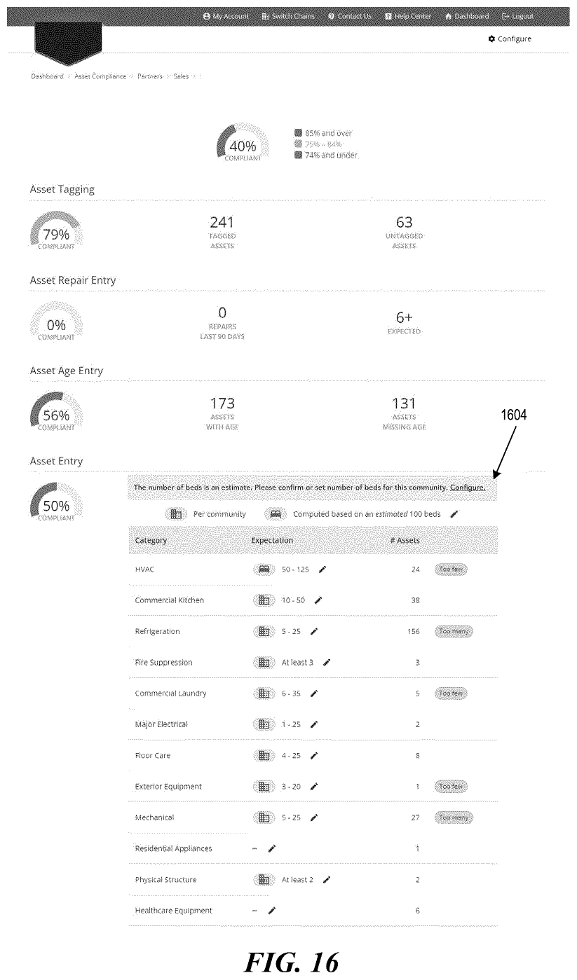

Once the process 100 has gathered both actual values and recommended or expected values for asset attributes, these data are input into an ensemble model suite configured to identify and categorize data gaps for each asset record in operation 126. The ensemble model can comprise a missing data model, a duplicate data model, a stale data model, an anomalous data model, and an unverified data model. Each model is trained to detect specific nonconformities in sub-operations, such as absent required attributes in operation 132, duplicate entries in operation 128, outdated information in operation 130, anomalous data in operation 134, or new or unverified data in operation 136. As illustrated by FIG. 16, a data gap can be displayed to a user as a prompt 1604 via a user interface of a resource compliance tool.

For every data gap identified, the ensemble model determines the relevant nonconforming attribute and assigns a fault type corresponding to the underlying data issue, for example, categorizing the gap as missing, duplicate, stale, anomalous, or unverified. Crowdsourcing methods and models, as explained herein, can likewise be included within the ensemble model. For example, when multiple facilities possess the same or similar assets, the system can reuse information from compliant facilities to fill in missing or incomplete data. Asset manuals, instructional videos, and other documentation available at one location can be referenced to supplement records at another. The ensemble model can also analyze patterns across assets and work orders, identifying common configurations or maintenance practices among facilities that consistently meet compliance standards. By aggregating and comparing data from these high-quality sources, the system can generate the prompt 1604, which can include recommendations for attribute values, as well as flagging discrepancies where a given record deviates from established norms.

The ensemble model suite can be architected as a collection of specialized machine learning and statistical models, each targeting a distinct category of data nonconformity within asset records. This approach can leverage the strengths of multiple models to improve detection accuracy and robustness. For example, the missing data model can be implemented using rule-based logic or probabilistic imputation techniques, such as expectation-maximization or k-nearest neighbors, to identify absent required attributes. This model can be further enhanced by training supervised classifiers on labeled datasets where missingness patterns are known, allowing the system to learn complex dependencies between asset attributes and more accurately flag missing data scenarios.

The duplicate data model can use a combination of fuzzy matching algorithms, such as Levenshtein distance or Jaccard similarity, and clustering techniques to detect records that represent the same asset but can have minor variations in attribute values. Advanced implementations can employ deep learning models, such as Siamese neural networks, which are trained to learn similarity metrics between asset records based on both structured and unstructured data fields. These models can be calibrated to account for common data entry errors, typographical variations, and synonym usage, thereby reducing false positives and improving the precision of duplicate detection. In addition to identifying duplicate data—where the same asset appears two or more times in the database—the model can also facilitate reconciliation by merging or flagging redundant records for review. Furthermore, the model can address overlapping data scenarios, such as when records for old and new assets coexist due to incomplete decommissioning or replacement processes.

To address stale or out-of-date data, the stale data model can incorporate time-series analysis and change detection algorithms. For example, the model can monitor the age of each attribute value relative to predefined thresholds or industry standards, flagging information that has not been updated within an expected interval. In this context, the model can specifically attend to attributes such as asset type or model, the age of the asset, results from condition assessments (e.g., including photos), and the asset's repair history. For example, the stale data model can compare the time elapsed since a previous condition assessment of an asset to an expected frequency or recommended interval for condition assessments (e.g., according to asset type). The model can flag assets that are overdue for evaluation based on this comparison. A condition assessment can include capturing one or more images of the asset, assigning a condition score or rating, and recording relevant notes.

The model can also evaluate data freshness at both the facility level (e.g., requiring updates every two months) and the individual asset level, ensuring that preventative maintenance records are current and accurately reflect the asset's operational status. More sophisticated approaches can use survival analysis or recurrent neural networks to predict the likelihood that a given data point has become outdated, based on historical update patterns and external triggers such as warranty expirations or regulatory changes.

The stale data model can generate a data gap based on a record of a resource that requires condition assessments on a regular cadence (e.g., annual, bi-annual, monthly, weekly, or daily); as in, for example, a discontiguous network that includes a municipal water utility required by regulation to perform a condition assessment of each water storage tank on an annual basis. By comparing a known attribute (e.g., condition assessment date) with an actual value (e.g., the most recent condition assessment date) against the expected attribute and its recommended value (e.g., the recommended date of the most recent condition assessment), the stale data model can detect that more than twelve months has elapsed since the last assessment, and then generate a data gap for the resource record, where the condition assessment date attribute is marked as a nonconforming attribute of the data gap, and the most recent condition assessment date is marked as an invalid value. The resource management system can use this output to generate a request for a service that includes a reactive maintenance tool (e.g., a task tool) to perform a condition assessment of the water storage tank, as well as a deliver a notification to a facility manager of the water utility regarding the data gap and the associated noncompliant resource.

The anomalous data model can be implemented using statistical outlier detection methods, such as z-score analysis, isolation forests, or autoencoders. These techniques enable the identification of attribute values that deviate significantly from the norm, either within a single facility or across the entire asset database. The model can be trained on historical data to learn typical value ranges and correlations, allowing it to flag entries that are statistically improbable or inconsistent with related attributes. In some cases, the model can incorporate domain-specific rules or external reference data to further refine anomaly detection.

The unverified data model can leverage external validation sources, such as manufacturer databases, regulatory registries, or third-party certification platforms, to cross-check asset attributes. This model can be implemented using API integrations or web scraping tools to automate the verification process. Machine learning classifiers can be trained to assess the confidence level of each external match, taking into account factors such as data source reliability, recency, and completeness.

The ensemble model suite orchestrates the outputs of these individual models, aggregating their findings to assign a fault type to each nonconforming attribute and providing a comprehensive view of data quality across the asset inventory.

Alternatively, the ensemble model can include rule-based approaches to data gap identification. This approach can include defining explicit logical rules that compare each attribute in the asset record against its corresponding reference value. In this framework, the process 100 maintains a set of reference values for each asset attribute, which can be derived from corporate standards, industry best practices, historical data, or regulatory requirements. For every asset record processed, the system iterates through each attribute and applies a series of deterministic rules to evaluate conformity.

For missing data detection using a rule-based approach, the rule engine checks whether each required attribute in the record is present and non-null. If an attribute is absent or contains a placeholder value (such as “N/A” or “unknown”), the rule flags the attribute as missing. For duplicate detection, the system compares identifying attributes-such as serial numbers, asset tags, or location codes-across all records. If two or more records share identical or highly similar attributes, the rule flags them as potential duplicates.

To identify stale data using a rule-based approach, the rule-based system examines the timestamp or last update date associated with each attribute. If the elapsed time since the last update exceeds a predefined threshold (for example, if maintenance dates are older than the recommended interval), the rule marks the attribute as stale. For anomaly detection, the rules can specify acceptable value ranges or enumerated lists for each attribute. If a record contains a value outside these bounds (such as a purchase date in the future or a warranty period exceeding industry norms), the rule flags the attribute as anomalous.

Unverified data can be detected by rules that check for the presence of external validation markers, such as confirmation codes from manufacturers or third-party certifications. If the record lacks such verification, the rule categorizes the attribute as unverified. Each rule is designed to be transparent and auditable, making it easy to trace the logic behind each data gap classification.

The identified gaps and associated recommended values are then processed by a data gap prioritization model in operation 138, which outputs a priority score for each gap. The prioritization model calculates each score based on factors including the asset's criticality, potential compliance impact, operational risk, and the anticipated benefit resulting from gap correction.

The data gap prioritization model can be implemented using rule-based logic, statistical analysis, or machine learning techniques, either individually or in combination, to generate a priority score for each identified data gap. In a rule-based implementation, the system applies a set of predefined rules to assign priority scores. For example, the model can reference a weighted matrix in which data gaps associated with assets of higher criticality-such as those essential for safety or regulatory compliance—are automatically assigned elevated priority. Additional rules can increase the priority score if the gap is likely to impact compliance, operational risk, or if historical records indicate that addressing similar gaps has produced significant operational improvements. These rules can be encoded as decision trees or conditional logic statements, providing a transparent and auditable prioritization process.

Alternatively, the prioritization model can employ statistical methods to assess and rank data gaps. For instance, logistic regression or Bayesian inference models can be trained on historical incident data to estimate the probability that a particular data gap will result in compliance violations or operational disruptions. The model can then combine these probability estimates with asset criticality and anticipated benefit metrics to compute a composite priority score. Statistical approaches can further incorporate measures of uncertainty, enabling the system to flag data gaps where risk assessments are less certain and can require additional review.

In some implementations, the data gap prioritization model can use machine learning approaches to compute priority scores for data gap remediation. Such approaches can include random forests, gradient boosting machines, or neural networks, trained on labeled datasets in which prior data gaps have been scored or ranked by subject matter experts. These models can include random forests, gradient boosting machines, and neural networks to identify and model interactions among input variables that can be complex or non-linear. These input variables can include asset classification, asset criticality, historical compliance records, operational risk metrics, and detailed attributes of each identified data gap. Advanced implementations can also leverage natural language processing to extract relevant information from unstructured data sources, such as maintenance logs or incident reports, or employ reinforcement learning to refine prioritization strategies based on feedback from gap remediation outcomes. Such machine learning-based approaches can enable the prioritization model to adapt to evolving operational environments and continuously improve its performance over time.

For each priority data gap, the record, nonconforming attribute, and assigned fault type (e.g., missing, unverified, anomalous, out-of-date, or redundant) are input to a resource association model, which is trained to generate a resolution pattern in operation 140. The resolution pattern can include a set of triggering conditions—for example, a specific user interaction or a scheduled maintenance event—and one or more corrective actions targeted to address and resolve the data gap. The resolution pattern can include one or more of a series of workflows, illustrated by FIGS. 5, 6, 7, and 8, which can include a series of steps and decisions points that can be implemented by a service.

FIG. 5 illustrates a resolution pattern 500 that includes an asset breakdown 502 triggering condition and a planned replace 552 triggering condition. In some implementations, the process 100 can include associating the resolution pattern 500 with a work order service (e.g., reactive maintenance). An additional triggering condition can include a work order created event.

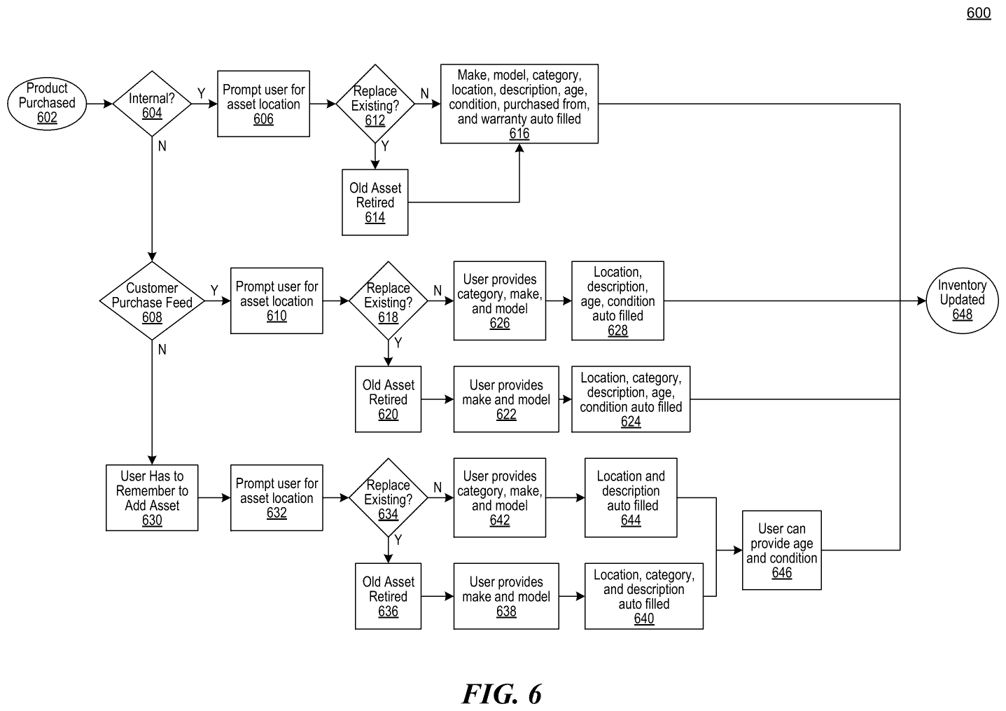

FIG. 6 illustrates a resolution pattern 600 that includes a product purchased event 602 triggering condition.

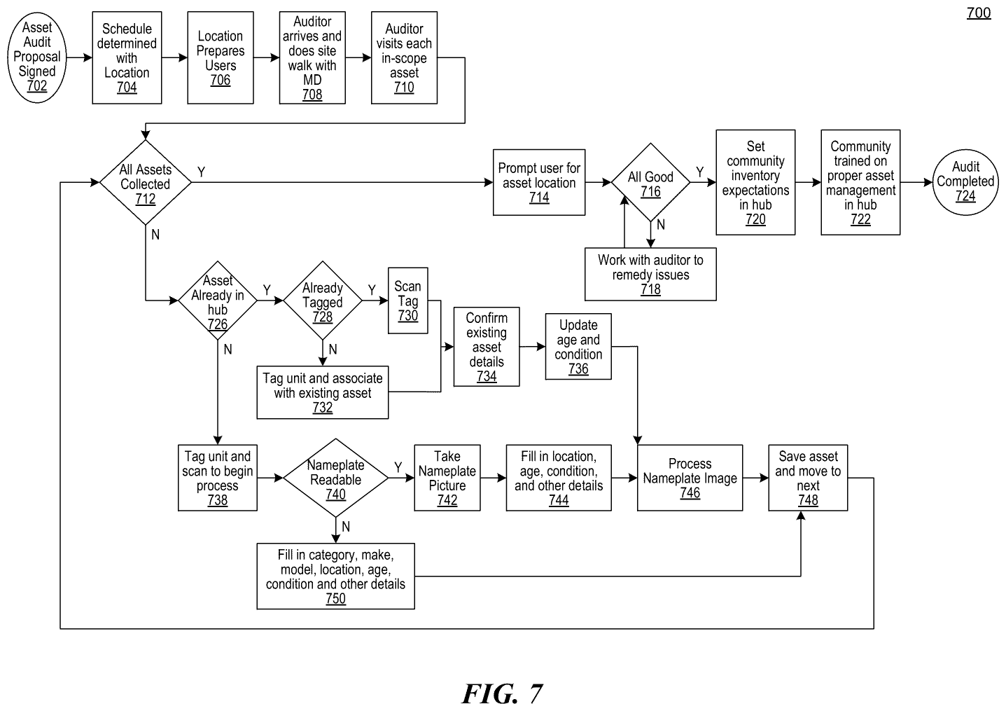

FIG. 7 illustrates a resolution pattern 700 that includes an asset audit proposal signed 702 triggering condition.

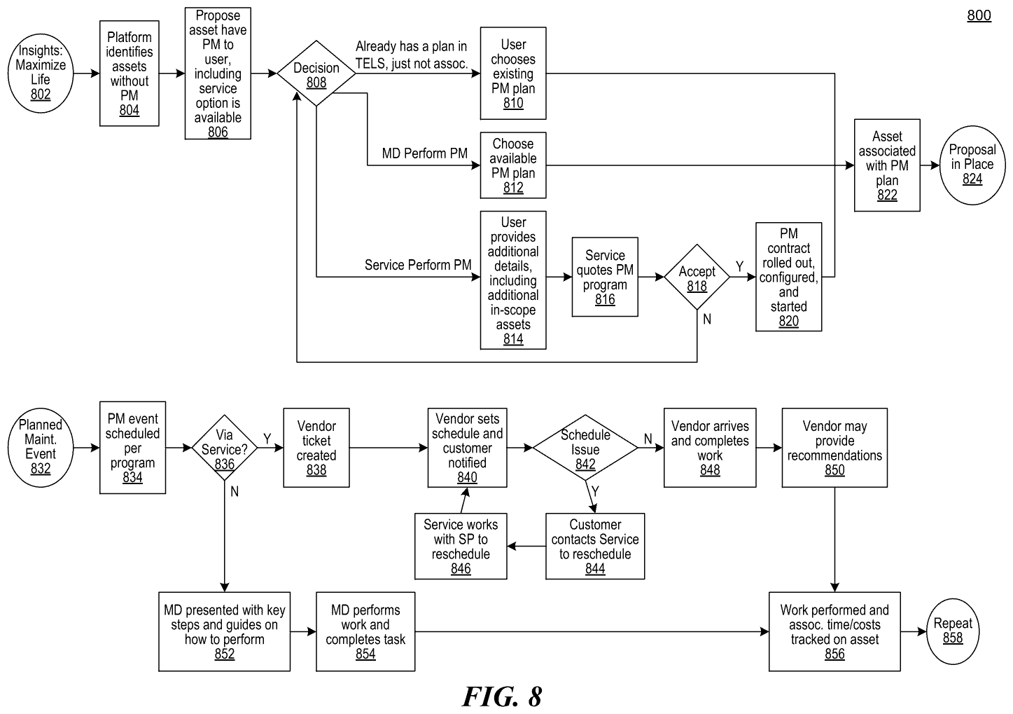

FIG. 8 illustrates a resolution pattern 800 that includes a planned maintenance event operation 832 triggering condition and an insights: maximize life operation 802 that acts as a triggering condition to the resolution pattern 800.

The resource association model can be implemented using a range of technical approaches. In a rule-based implementation, the model can apply predefined mappings between fault types, nonconforming attributes, and corrective actions, such as associating a missing calibration record with a scheduled calibration workflow or linking a specific fault code to a standard repair procedure. These mappings can be encoded as lookup tables or decision trees, enabling rapid and transparent association of resources and workflows. Alternatively, a statistical approach to resource association can leverage historical resolution data to identify a most effective corrective action for a given fault type and data gap, using techniques such as frequency analysis or Bayesian inference to estimate the likelihood of successful resolution patterns. For more advanced implementations, a machine learning-based resource association model can be trained on historical records of data gaps, user interactions, and resolution outcomes to predict optimal resolution patterns. Such implementations include random forests, support vector machines, and/or neural networks, and incorporate features such as asset type, user role, event context, and prior resolution success rates. The output of the model is the resolution pattern, including a recommended set of triggering conditions and corrective actions-including multi-step workflows and decision points.

The process 100 can generate a request for a service to address the priority data gaps in operation 142, matching recommended corrective actions to available service capabilities, whether automated or manual.

In some implementations, the process 100 generates the request after detecting the triggering condition in operation 144. The triggering condition can be satisfied by a variety of request triggers, each designed to initiate a service request for addressing a data gap associated with an asset. The specific nature and timing of the request are determined based on the type of data gap, the operational context, and the configuration of the system.

One type of trigger is asset-based. In this implementation, a request can be generated when data indicates that a specific asset is currently being worked on or is scheduled for work by the user. This determination can be made based on information from work orders, scheduled tasks, unit turns, or site visits, and can further consider the scheduled timing of such work. For example, if a user initiates or is assigned a work order for a particular asset, the process 100 can trigger a request to address any outstanding data gaps related to that asset.

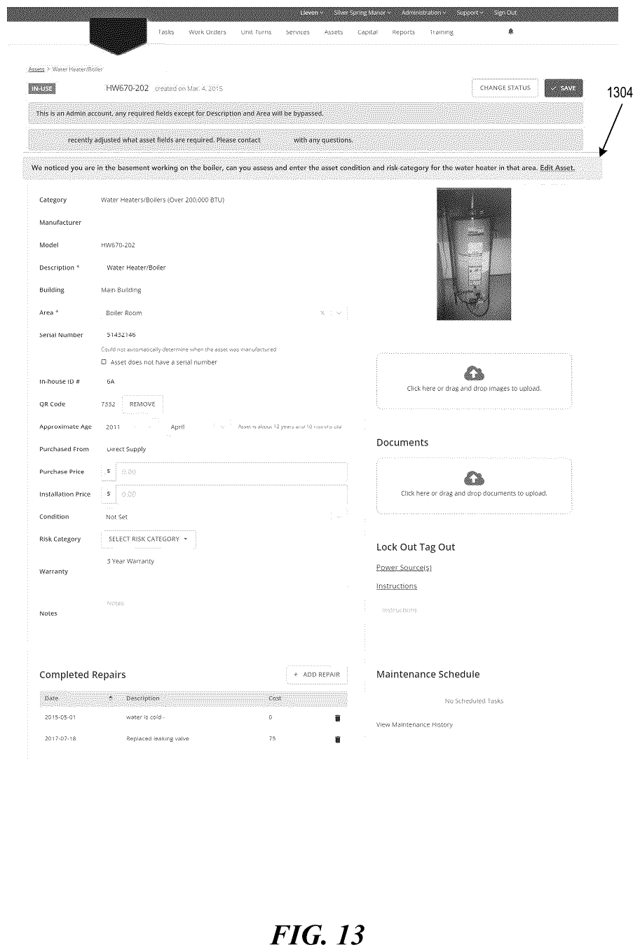

Another type of trigger is location-based. Requests can be triggered based on dynamic, contextual, and real-time data indicative of the user's current or scheduled location. This can include information derived from work orders, tasks, or site visits, as well as real-time location data obtained from the user's mobile device, such as GPS, WiFi, Bluetooth beacons, or proximity sensors. In some implementations, the presence of assets in proximal locations can also trigger a request. For example, when a user enters a specific area or facility, the system can push a notification to the user's device to address data gaps for assets located within or near that area. As illustrated in FIG. 13, such notifications can be displayed as a banner on a user interface of a work order service (e.g., reactive maintenance) accessed by a user via an application.

Location-based triggers can include dynamic-composite user location data. The process 100 can include receiving and processing dynamic-composite user location data from a variety of tools and platforms. This data can originate from the resource management platform, integrated systems, or third-party connected systems. This data can be used by a user location model to determine or predict the user's current or scheduled future location. The user location model can be implemented using the various methods described below and herein (e.g., by relying on contextual data of assets, the likely location of a user, and/or actual positioning data).

The location data can be granular, such as a specific facility, area, or room, or it can be more contextual, such as an asset associated with the work being performed when explicit location information is unavailable. In some cases, indirect contextual data-such as an asset serial number—can be used to identify the asset, which in turn can be mapped to a physical location using an asset database.

The sources of user location data are diverse and can include integrated systems such as work order management tools, task tracking modules, unit turn tools, site visit tools, the resource management platform, and other computerized maintenance management system (CMMS) tools. Additionally, third-party systems, such as electronic medical record (EMR) systems used by a facility or organization, can be integrated to provide supplementary data for determining a likely location of a user. The process 100 can also include leveraging actual positional data, including GPS coordinates, WiFi or Bluetooth beaconing data, inertial positioning data, RFID, or NFC signals, which can be captured in real-time from the user's mobile device.

Location or asset information can be received from the tools or systems described herein in real-time, reflecting a user's physical proximity to an asset or location at the time work is being performed. For example, when a user opens a work order or uses the site visit tool, information obtained from the tool can be used to infer the user's current location. In some cases, this determination can be made preemptively and stored for later use, rather than being processed in real-time. If only an asset identifier is available from the active tool, the system can query the asset database to retrieve the corresponding location information.

In addition to real-time data, the system can use information related to scheduled work to predict the user's expected location at a future time. Certain tools provide data indicating when and where a user is scheduled to perform work, such as repairs or inspections, in a particular area or in relation to a specific asset. This scheduled location data can be similar to the data used for real-time location determination but is assessed preemptively and includes a temporal component, such as the scheduled day, time, or time range. This temporal data is particularly useful for prompting or notifying users ahead of scheduled work, such as for tasks planned for the current week, day, or specific time slots. Scheduled work data can also be sourced from calendar applications or scheduling modules.

In some instances, additional processing of available data is required to detect or infer the user's location or the relevant asset. For example, the system can analyze the description field of a work order to extract a room number or asset serial number, which can then be used to determine the location or asset being addressed. It is important to distinguish that “real-time” data refers to information obtained from a tool or system being actively used by the user at a given moment, such as an open work order or task, as well as mobile device location data. However, real-time data can also include stored work order or task data that is processed to infer location, even if not captured at the precise moment of user activity.

In addition, requests can be triggered when asset data is loaded from external systems. For example, when an asset is purchased through a connected procurement platform, the system can trigger a request for the user to confirm or validate the new data, retire outdated assets, or perform other relevant actions. In some implementations, such requests can be further conditioned on location-based criteria, such that the request is only triggered when the user is present at or within a distance to a relevant site, where the distance is below a threshold maximum distance.

One such resolution pattern is illustrated below in FIG. 6, for addressing a data gap created by a product purchased event 602.

Each of the triggers herein can incorporate a time-based component to determine whether a request should be generated. For example, if an asset or a nearby asset has not been edited, repaired, or maintained within a configurable period-which can vary by asset category or type—the system can request the user to validate the asset's status and details. Similarly, if a condition assessment is expected at regular intervals and has not been completed, the system can generate a request reminding the user to perform the assessment. The timing and frequency of such requests can be configured based on organizational policies or regulatory requirements.

Triggers can also be based on budgetary or cost considerations. For example, if the cumulative repair costs for an asset exceed a predefined threshold, the system can request the user to consider obtaining a replacement quote, providing a direct link to initiate the process. This ensures that financial considerations are integrated into the asset management workflow.

Triggers can also be based on a user's role, the type of work that needs to be performed, and the urgency level of the corrective action. For example, the process 100 can include an operation in which a user is determined to be best suited to respond to a priority data gap (e.g., maintenance need), based on an assigned role, a permission, or an area of expertise. When a trigger condition is met, the operation can automatically send a prompt or notification to the appropriate user or group of users, specifying the required action and its urgency. For example, if a high-priority corrective action is identified-such as a critical safety inspection that is overdue—the system can send an immediate notification to a supervisor or safety officer, while routine maintenance reminders may be directed to field technicians. The content, delivery method, and escalation path of the notification can be dynamically adjusted based on the user's role (e.g., administrator, technician, manager), the type of work (e.g., inspection, repair, data validation), and the urgency level (e.g., critical, high, normal, low).

Triggers, or requests, can be generated along with recommendations for repair or replacement actions based on historical data and predictive models, in operation 142 or operation 144. When a user enters or validates asset data in response to a request, a repair-vs-replace model can process the new information and output a recommendation. The user can then be able to initiate a work order or capital request directly from the request interface.

The repair-vs-replace model described herein can be implemented using a variety of technical approaches. In some implementations, a rule-based repair-vs-replace model can be employed. This model can use a set of predefined business rules and thresholds to determine whether a repair or replacement action should be recommended for a given asset. Methods include using a financial analysis technique such as lifecycle cost analysis comparing total cost of ownership for repair versus replacement. For example, the system can be configured to recommend replacement if the cumulative repair costs for an asset exceed a specified percentage of the asset's replacement value, or if the asset has experienced a threshold number of failures within a defined time period. Additional rules can incorporate factors such as asset age, warranty status, criticality, and compliance requirements. These rules can be encoded as decision trees or conditional logic within the system, providing a transparent and auditable framework for generating repair or replacement recommendations in response to service requests.

In other implementations, the repair-vs-replace model can leverage statistical analysis to generate more dynamic and data-driven recommendations. A statistical approach can involve analyzing historical maintenance records, failure rates, and cost data to estimate the expected remaining useful life (RUL) of an asset, the probability of future failures, or the total cost of ownership under different scenarios. These statistical estimates can be used to calculate metrics such as net present value (NPV) or return on investment (ROI) for repair versus replacement options, enabling the system to recommend the most cost-effective action in response to a service request.

For more advanced implementations, the repair-vs-replace model can use machine learning algorithms (e.g., logistic regression, random forests, or neural networks) trained on historical asset data to predict the likelihood of future failures, maintenance costs, or downtime associated with repair and replacement decisions. The model can incorporate a wide range of features, including asset type, usage patterns, environmental conditions, repair history, and sensor data. The output of the machine learning model can be a probability score or classification indicating whether repair or replacement is the optimal action and can optionally provide an explanation of the factors influencing the recommendation.

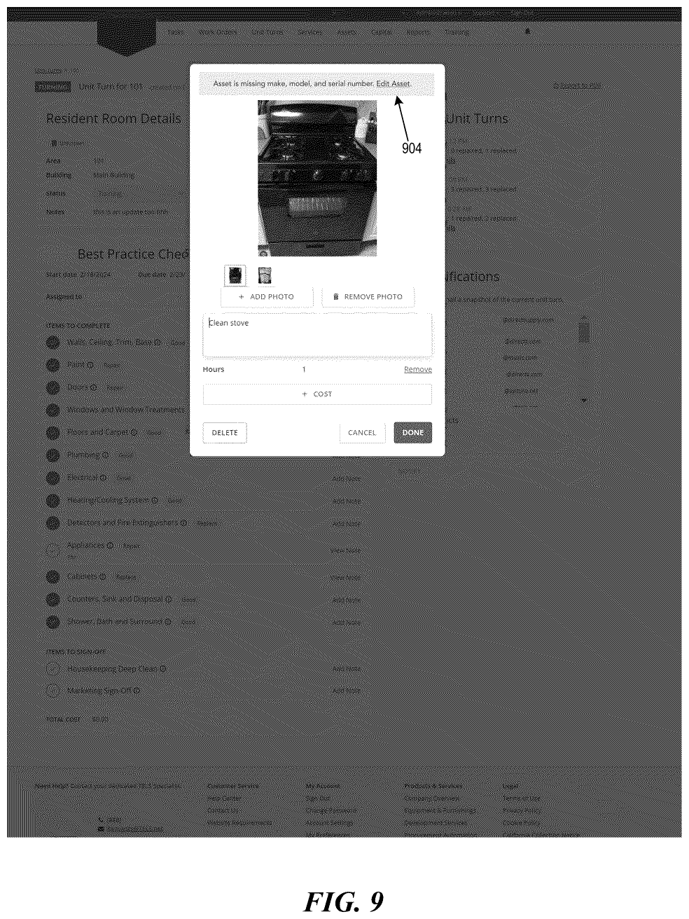

The service can include a facility or organization dashboard, and the request can include a notification displayed on a user interface (UI) of the dashboard, as illustrated herein by FIGS. 9, 10, 11, 12, and 13.

The service can include a message or communication sent to a user associated with the system, for example, as an email, or an SMS. The service can include a work order application for reactive maintenance in an operation 146, or it can include a task application for proactive maintenance in an operation 148. Generating the request can include creating a work order for data gaps with a priority exceeding a critical threshold (e.g., critical data gaps). In some implementations, generating the request includes assigning it to a task that is pre-existing or regularly scheduled. For example, in some implementations, the operation 142 includes assigning the work order to a technician to gather missing physical asset information, or to prompt an administrative user to validate or retire outdated data.

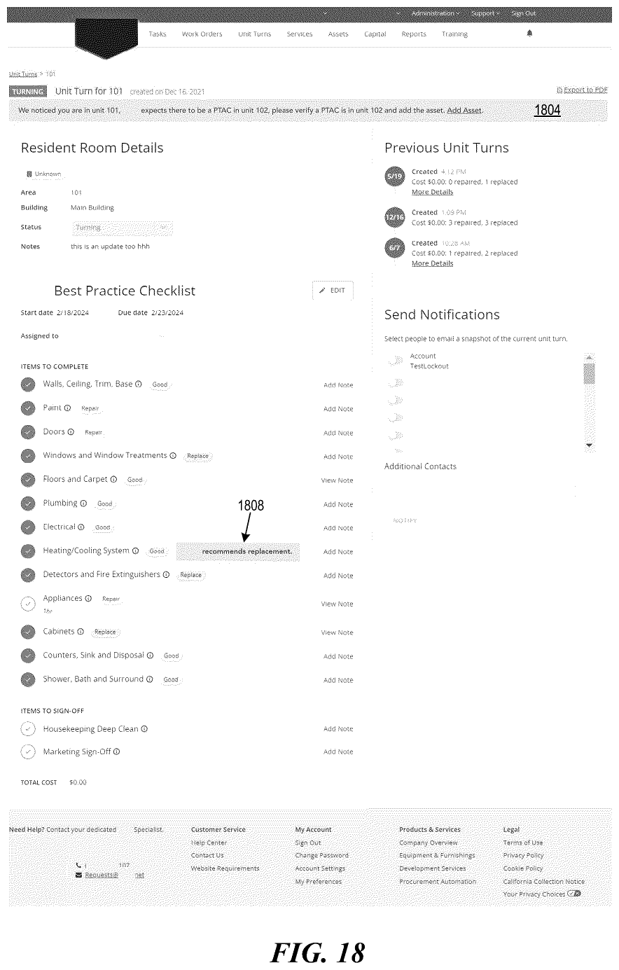

In some implementations, the service includes a unit turn tool. As illustrated in FIG. 18, the unit turn tool can be accessible via a user interface, in which a request to the tool can be displayed for users as a recommendation 1808. As illustrated in FIG. 9, the unit turn tool can also include a user interface that allows for dynamic prompting of users, including a prompt 1804 to users to provide input to remediate a priority data gap associated with a resource included in a unit turn. The service can include a unit turns tool within the resource management platform, which is designed to streamline and enhance the process that occurs when a resident vacates a unit. A unit turn can be automatically triggered by an integrated electronic medical record (EMR) system when a resident's departure is recorded. During the unit turn process, maintenance activities are performed on the unit, and relevant asset data-including repairs, replacements, and condition assessments—can be added directly to the system. The unit turns tool supports a dynamic location-based prompt 1804, as illustrated. The prompt 1804 can be similar to those used in resource compliance, enabling users to enter, edit, or validate information for a specific asset or for assets in nearby areas or rooms, even outside the standard unit turn workflow. For example, if an asset's purchase date is missing for a particular unit, the system can send the prompt 1804 to the user to provide an approximate purchase date. Additionally, users can receive the prompt 1804 to add or update asset condition information, such as assigning a condition rating or capturing images of the asset's current state. The prompt 1804 can occur both within and outside the normal unit turn workflow, ensuring comprehensive and up-to-date asset records. The unit turns tool also facilitates the automatic loading of asset data, repairs, and maintenance records for items addressed during the unit turn, and enables the collection of asset condition data in real time. This allows the system to track the useful life, common repairs, and maintenance history of assets-such as those that are frequently replaced-thereby supporting both marketing users conducting unit assessments and maintenance directors (MD users) performing unit maintenance.

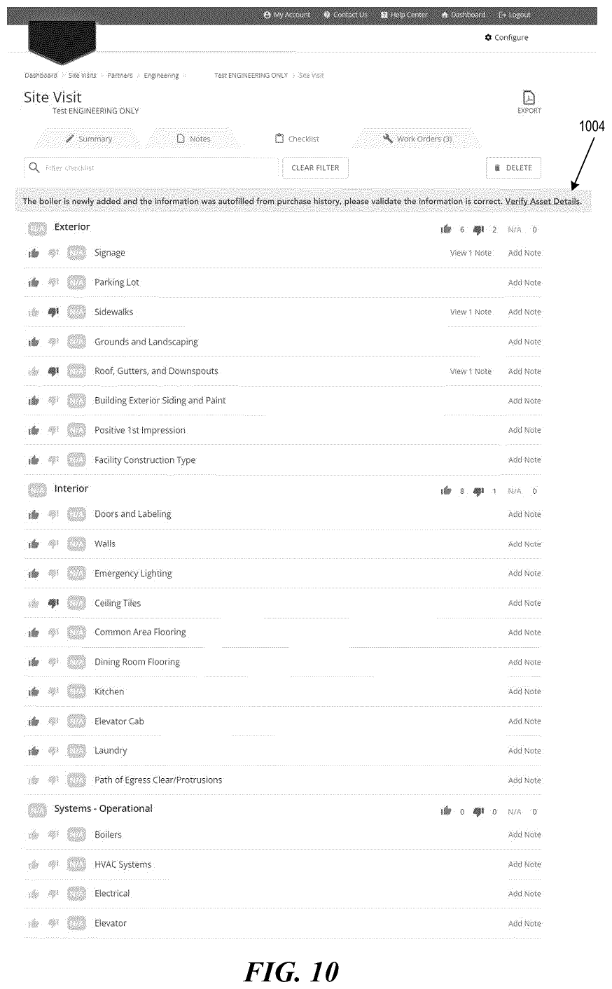

In some implementations, the service includes a site visit tool. As illustrated by FIG. 10, the site visit tool can be displayed via a user interface on a device accessible to users through an application. In some implementations, the site visit tool facilitates comprehensive asset audits of facilities by corporate or regional users. This tool can connect to capital planning tools, to enable users to systematically audit buildings and facilities to identify and collect capital items for inclusion in the capital planning process. During a site visit, users can be prompted within the normal workflow to validate capital needs and update the list of assets that must be entered or reviewed. The tool can also prompt users to initiate repair or replacement actions for assets based on historical data or newly validated information.

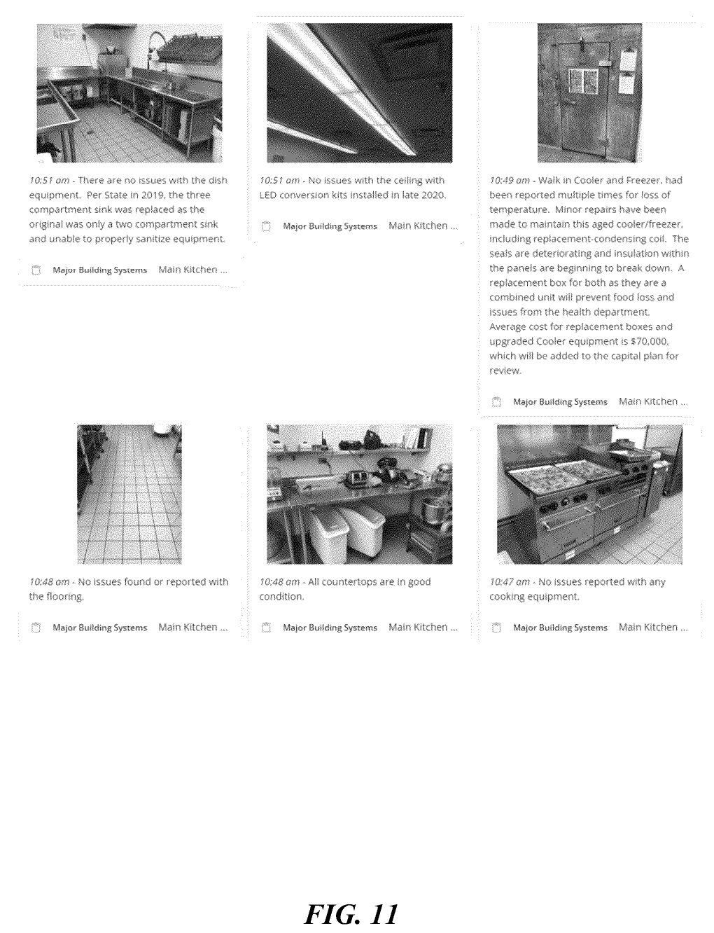

For example, if new data indicates an asset is in poor condition or past its useful life, the tool can prompt the user to consider whether the asset should be repaired or replaced. The site visit tool leverages dynamic location-based prompts, presenting users with prioritized banners or notifications-especially for high-value or critical assets-based on the specific area of the facility currently being assessed. For example, if a user is evaluating the boiler room, the tool can trigger a prompt related to the boiler or a nearby asset, taking into account factors such as useful life, last condition assessment, and any notes from community users like maintenance directors. If a maintenance director has previously noted that a boiler is in poor condition, the site visit tool can prompt the user with a message such as, “The Boiler is 10 years past its useful life, please verify whether the asset should be repaired or replaced,” thereby supporting informed decision-making and timely action. As illustrated in FIG. 11, the site visit tool can include a log of input provided by the user to the tool. Additionally, the platform can extend dynamic location-based prompts to other survey and site visit tools, such as mock survey tools for CMS compliance or dietary assessments. In these scenarios, users can be prompted-based on their current work location or the specific area being assessed—to enter, edit, or validate asset information, add or tag assets, or address asset gaps, ensuring thorough and up-to-date asset records across all facility areas.

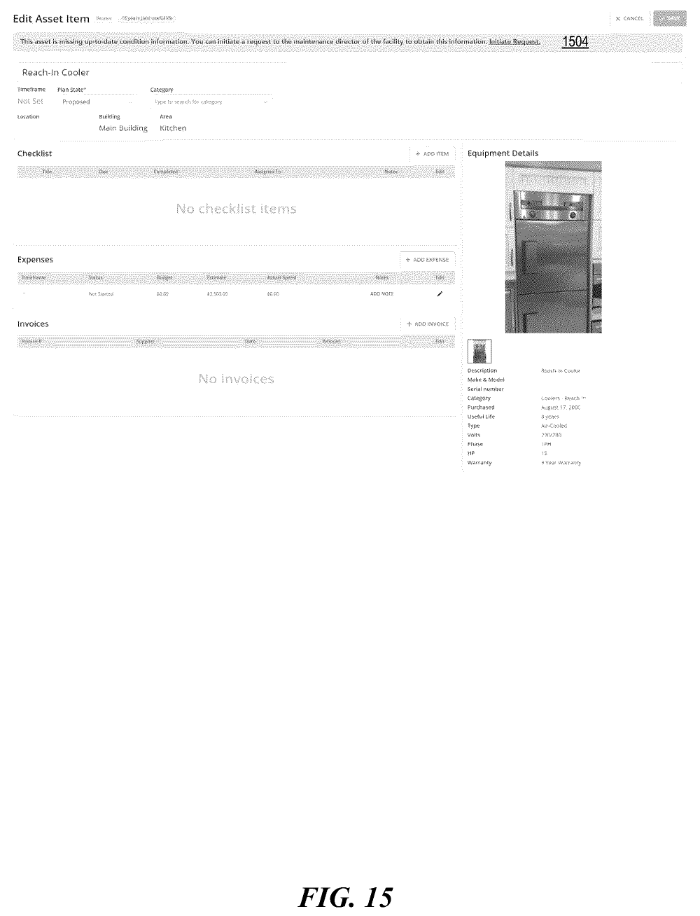

In some implementations, the service includes a capital planning tool. As illustrated in FIG. 15, the capital planning tool can enable community, regional, and corporate users to collaboratively manage and optimize capital asset planning across facilities. In this tool, a community capital user can propose new items for inclusion in their facility's capital plan, with the ability to validate or add asset details as part of the proposal process. These proposals can be reviewed by a corporate user, who determines whether and how to incorporate the items into the broader capital plan, which can span multiple years. Throughout this resolution pattern, the capital planning tool leverages dynamic location-based prompts-similar to those in the site visit tool—to address data gaps. For example, when a user proposes an asset, the tool can prompt them to enter, edit, or validate missing asset details, either for the asset in question or for another asset in a nearby location. Corporate capital users, upon reviewing proposals, can receive a prompt 1504 to request missing asset information, which can include user interface elements for initiating targeted emails, notifications, or work orders to the facility's maintenance director to gather the required data (e.g., “This asset is missing up-to-date condition information. Click here to initiate a request to the facility's maintenance director to obtain this information”).

The tool can also provide the prompt 1504 with capital plan recommendations based on factors such as preventative maintenance history, repairs, useful life, condition assessments, warranties, and asset forecasting. For instance, the tool can recommend including an asset in a future capital plan based on its repair and maintenance history. Corporate users can set and manage asset categories, including useful life and replacement cost, and can receive data-driven prompts to update these parameters based on organizational or industry-wide performance trends (e.g., “The system recommends increasing the useful life of the Cooktops Asset Category to 10 years based on historical performance. Click here to make that change.”).

As part of the capital planning process, when a capital asset item is completed (i.e., reaches end of life), the tool can check to ensure the asset is replaced in the inventory. If the asset is purchased through an integrated supplier, the asset and its information can be automatically added to the inventory and capital plan, subject to user approval via automated notifications or prompts. If the asset is purchased outside the integrated supplier, facility users can be prompted to record the replacement, entering details such as make, model, category, location, description, age, and condition, through alerts, emails, or work orders directed to the appropriate user. The tool can also automatically retire the old asset and generate prompts to verify its retirement, ensuring accurate and up-to-date asset records throughout the capital planning lifecycle.

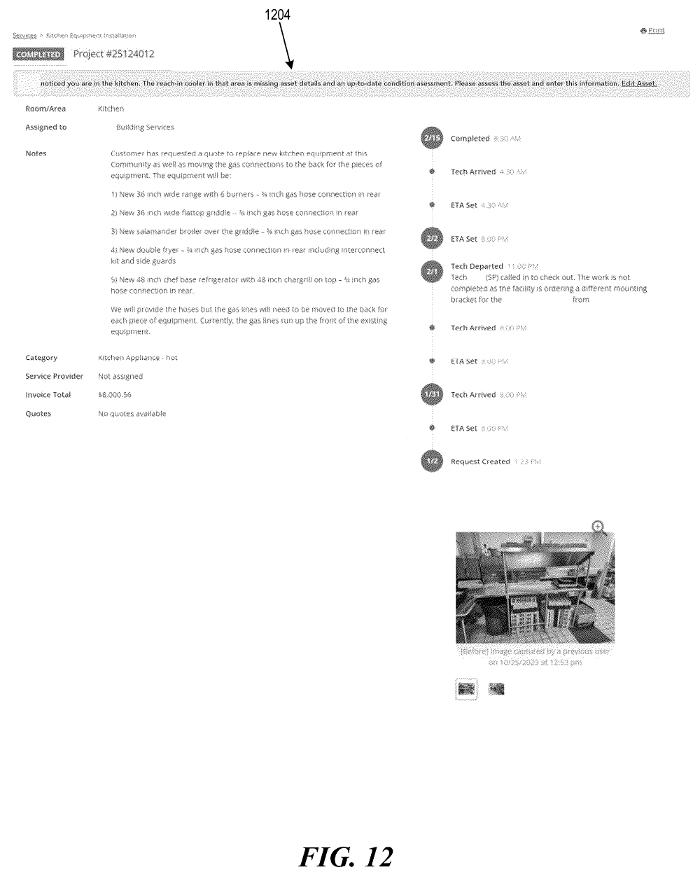

In some implementations, the service includes a service-provider tool. As illustrated by FIG. 12, the service-provider tool can include a user interface, wherein requests for the tool can be displayed as notifications for a user, and allow for user input to remediate the priority data gap associated with the request. In some implementations, the service-provider tool streamlines the management of service work performed by technicians. This tool enables technicians to efficiently manage installations, replacements, and repairs, with seamless integration into the broader platform. When service work is completed, the tool can automatically load relevant asset data-including installation details, replacement history, and prior repairs-into the system. Technicians are then prompted to validate asset data and enter any missing information to address asset data gaps. The tool can be configured to always prompt technicians to capture an image of the asset and/or scan a unique QR tag upon completion of work, ensuring accurate and up-to-date asset records. Leveraging dynamic location-based prompts, the system can prompt technicians to enter, edit, or validate information not only for the asset they are servicing but also for nearby assets, similar to resolution patterns in work order and asset management systems. Additionally, the service-provider tool supports repair/replace prompts for facility users, such as maintenance directors (MDs), when requesting service quotes. For example, if a facility user requests a replacement for an asset, the system can present a prompt recommending repair instead, based on factors such as the current capital budget (e.g., “The system recommends repairing this asset due to the status of your Capital Budget for 2024. Click here to change the request to a repair.”). Conversely, if a repair request is made for an asset that is past its useful life and has incurred significant repair costs, the system can prompt the user to consider replacement (e.g., “X has already been spent on repairs for this asset, which is past its useful life; you should consider getting a quote to replace the system. Click here to get a quote.”).

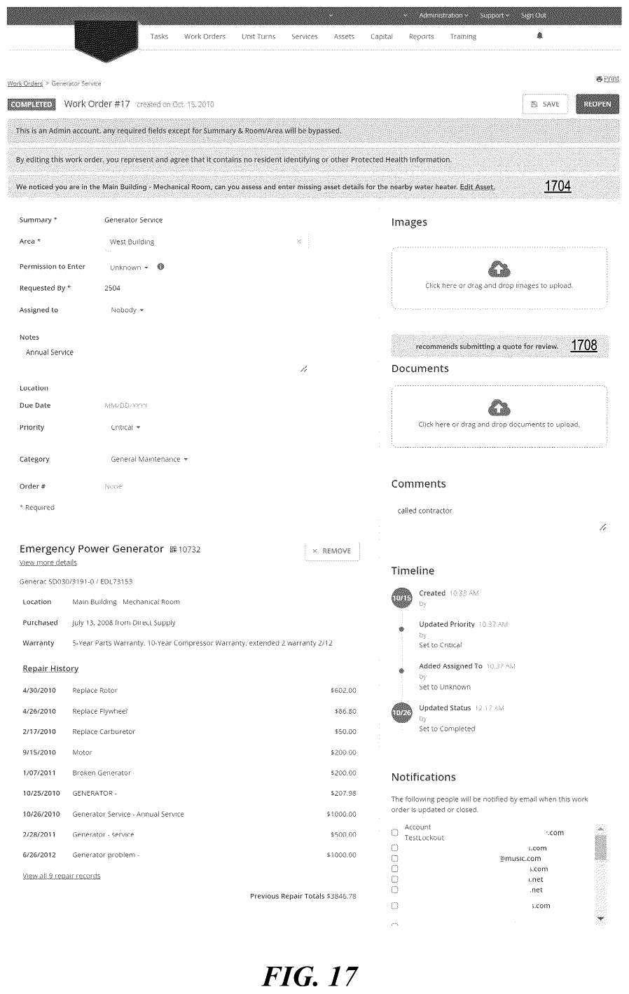

The service can include a reactive maintenance tool (e.g., for single work orders) and a proactive maintenance tool (e.g., for regularly scheduled tasks). As illustrated by FIG. 17, the reactive maintenance tool can be displayed to a user via a user interface, whereby requests can be displayed to the user as a notification 1704. Additionally, as illustrated, input can requested from the user by the tool as a recommendation 1708 for the remediation of the priority data gap.

Following this detection, associated with a resolution pattern has been satisfied-such as a user accessing the asset record, or a scheduled event occurring—the process 100 can initiate a remediation action.

In some implementations, the remediation action includes an operation 146, which includes a reactive maintenance action (e.g., creating a work order to address the data gap associated with the asset), or an operation 148, which includes a proactive maintenance action (e.g., linking the request to pre-existing and regularly scheduled task associated with the asset).

The process 100 can include an operation 154 of providing scheduled notifications. These can be recurring notifications delivered within the application, or via a communication, or email. They can contain a prioritized, filtered, or grouped list of asset gap requests. Such notifications can be tailored to the user based on asset criticality, user responsibilities, or the schedule of planned work for a relevant time frame, such as daily or weekly. The scheduling of these notifications can be determined by analyzing data from scheduled work orders, tasks, or other planning systems.

The process 100 can include an operation 152 of presenting a dashboard overview or a gaps list. The gaps list can be a prioritized, grouped, or filtered list of asset gap requests. This list can be tailored to the user's role, relevance, responsibilities, or planned work schedule, allowing users to efficiently address outstanding data gaps in a manner aligned with their operational context. The operation 152 can include displaying requests to the dashboard as messages on a user interface (UI), as illustrated by FIGS. 9, 10, 11, 12, and 13. The dashboard view can include maps, e.g., facility maps, and asset maps, which can include real-time locations of available users, as well as recommended routes for a selected user based on a determination of a shortest path between assets with priority data gaps determined by the process 100.

The invalid value for the nonconforming attribute is replaced or updated using the output of the designated service in operation 150. Operation 150 can be automated or require user input.

To facilitate and drive user participation in the compliance process, the process 100 can generate clear and actionable notifications or messages. These prompts can be presented to users within the user interface of the asset management software, as mobile notifications, on the dashboard views, or in direct communications such as email or system alerts. In scenarios where remediation is partially user-driven, the system records user input as the service output, recording the correction and updating the record of the resource accordingly.

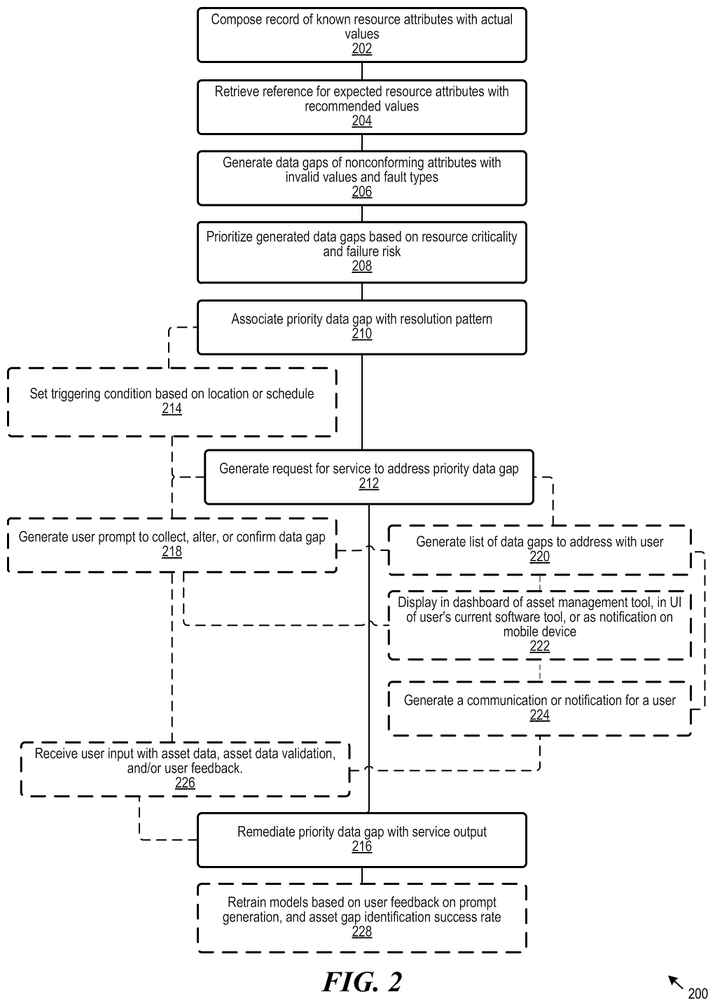

FIG. 2 illustrates a flowchart depicting for improving resource data compliance and integrity, in accordance with example implementations. The process 200 begins at operation 202, where a record of known resource attributes with actual values is composed. This composition can involve matching common identification values from multiple data sources associated with one or more systems in a discontiguous network.

At operation 204, a reference for expected resource attributes with recommended values is retrieved. This reference can be generated based on factors such as financial needs, risk factors, industry standards, or user input.

At operation 204, the system retrieves a reference for expected resource attributes with recommended values by dynamically generating or accessing a configuration profile tailored to the organization's specific context. Operation 204 can include evaluating corporate configurations and asset standards stored within the internal resource hub or a centralized configuration management system. These configurations include resource attributes like financial needs, risk tolerance, industry standards, and operational requirements (e.g., type of care provided, facility geography, seasonality, and asset category). Operation 204 can include applying these attributes to determine compliance criteria and asset management strategies, such as whether assets should follow a “run to failure” or “proactive maintenance” replacement strategy, which can be set at the asset category level.

Operation 204 can include referencing a set of required and prioritized asset fields. Some fields (e.g., asset name, type, and location) are universally required, while others (such as warranty information or purchase date) can be designated as required or optional by corporate users. This can allow organizations to enforce data completeness and prioritize fields based on operational or regulatory needs. For specific asset types, such as generators, the system can enforce additional requirements (e.g., mandatory photo documentation, purchase year, and condition assessment).

Next, operation 204 can include determining expected asset quantities for each facility, area, or category. This can be achieved by referencing corporate rules and leveraging statistical models-such as an expected assets model trained on historical data from similar facilities. The model can incorporate variables like facility square footage, number of beds (from EMR data), facility age, location, and care type to recommend the appropriate quantity or range for each asset type. For example, operation 204 can include recommending that each resident room contains a refrigerator, oven, microwave, and dishwasher, and that each facility is equipped with fire suppression and security systems.

Additionally, operation 204 can include retrieving facility-specific information (e.g., square footage, year of construction) and applying corporate run rules (such as appliance replacement intervals) and replacement strategies (e.g., “run to failure” for PTAC units, “proactive replacement” for boilers). Operation 204 also considers the organization's risk tolerance, which can influence recommended values and compliance thresholds. Automated recommendations for configuration settings can be generated by operation 204 based on analysis of successful configurations in similar facilities, further refining the reference for expected resource attributes.

The process 200 includes operation 206, where data gaps of nonconforming attributes with invalid values and fault types are generated. This generation can be performed by inputting the actual values of the known attributes and the recommended values of the expected attributes into an ensemble model. The ensemble model can include various sub-models such as a missing resource model, a duplicate resource model, a stale resource model, an anomalous resource model, and an unverified resource model. The ensemble model can be implemented according to the various examples described herein, with particular reference to the operation 126 of the process 100 in FIG. 1.

At operation 208, the generated data gaps are prioritized based on resource criticality and failure risk. This prioritization can be performed by inputting the identified data gaps and the recommended values of the expected attributes into a data priority model. The data priority model can be trained to output scores for the data gaps; for each identified data gap, the data priority model can determine a priority score based on a resource impact score, a resource failure risk, and an anticipated gain from correction.

Once data gaps are generated, the operation 208 can include evaluating and ranking these gaps based on at least one of the following recommended values: resource criticality, resource failure risk, potential efficiency gain, potential operational gain, cost, resource location, and one or more external risk factors.

In some implementations, the operation 208 can include evaluating and ranking these gaps based on their potential impact on resource management, operational risk, and potential gains in efficiency from correcting these gaps. This prioritization is achieved by inputting the identified data gaps, along with recommended or expected attribute values, into a data priority model. The data priority model can be realized as a rules-based engine, a statistical model, or a machine learning (ML) model that has been trained to output a priority score for each data gap. Details for how these various implementations can be incorporated into a resource compliance process, e.g., the process 100 illustrated by FIG. 1, are provided herein, and also above with particular reference to operation 138.

The data priority model considers a variety of factors to determine the relative importance of each data gap. One factor is resource criticality, which measures the risk to residents or operations if a particular resource were to fail. For example, resources that are essential to safety or health, such as fire alarms or HVAC systems in critical areas, are assigned higher criticality scores. Another important factor is the risk of failure, which is calculated based on the resource's age, its current condition (e.g., as determined by human assessment, sensor data, or image analysis), and its maintenance history, including records of preventative maintenance, repairs, testing, and inspections.

Efficiency gains are also considered by the model. The system can group data gaps by physical proximity, such as those located within the same building or area, to optimize the allocation of resources for data collection or remediation. Alternatively, the model can group gaps by resource type, leveraging operational familiarity to reduce the time and error rates associated with addressing similar resources. Operational gains are assessed by evaluating the anticipated benefits to operations from correcting a data gap, such as improved regulatory compliance, reduced downtime, or enhanced reporting accuracy.

Cost factors are incorporated into the prioritization process as well. The model weighs the cost of replacing versus repairing a resource, taking into account both direct and indirect costs. Additionally, building or facility information, such as the facility's age, size, layout, care-type, and the expected inventory of resources, is used to influence both risk and operational priorities. The model also accounts for external risk factors, including geography, seasonality, weather, and other environmental conditions that can elevate the risk or urgency associated with certain resources or data gaps.

The data priority model can adjust the required data granularity based on the type and criticality of the resource. For lower-criticality resources, such as a resident's room Packaged Terminal Air Conditioner (PTAC), the model can prioritize the collection of basic data (e.g., the resource's presence, identification, and approximate age) over more detailed attributes (e.g., make, model, or serial number). In contrast, for resources with higher criticality or cost, the model can increase the weight assigned to detailed data attributes, recognizing their greater importance for risk management and operational planning.

The model outputs a priority score for each data gap. This score can include a resource impact score, which quantifies the operational or safety impact if the data gap remains unaddressed; a resource failure risk, which estimates the likelihood of resource failure based on historical and contextual data; and the anticipated gain from correction, which assesses the expected improvement in efficiency, compliance, or cost savings resulting from resolving the data gap. The data priority model can use a rules-based scoring system for deterministic prioritization or employ machine learning algorithms, such as regression, classification, or ranking models, that are trained on historical data to dynamically adjust weights and improve prioritization accuracy over time.

Prior to final prioritization, the system can filter out data gaps that fall below a certain risk or impact threshold. The remaining gaps can be grouped for batch remediation based on location, resource type, or operational context, further optimizing the deployment of resources. The output of the data priority model can include a prioritized list of data gaps, each with an associated priority score.

At operation 210, a priority data gap is associated with a resolution pattern. This association can be performed by inputting the record, the nonconforming attribute, and the fault type for the priority data gap into a resource association model. The resource association model can be implemented according to the various examples described herein, with particular reference to the operation 140 of the process 100 in FIG. 1. In some implementations, the resource association model functions by analyzing both loaded resource information and real-time user resolution pattern data to determine the most relevant associations between data gaps and resolution patterns.

The association process can occur through several mechanisms. In a direct association, when a user is performing work related to a particular resource-such as executing a work order (WO) or task explicitly linked to a resource—the system can directly associate the resource data gap with the location or identity of that resource. If the location of the resource is known, this information can be used to directly link resource gaps associated with that location.

Alternatively, the association can be predicted based on real-time data, including the title or description of the WO or task, or other contextual information such as the area, room, or unit where the work is being performed. For example, if a WO indicates that work is being done on a PTAC in room 101, the model can infer that any resource data gap for a PTAC in room 101—or more generally, any other resource gap in room 101—can be associated with the current resolution pattern.

The resource association model can also use proximity-based association, where the association is determined by the spatial relationship between resources. This includes resources located in the same room as the resource being worked on, resources in adjacent rooms (such as rooms 101 and 102), resources on the same floor, or resources within the same area (such as a kitchen or utility space). Proximity can be further refined or estimated using real-time location or positioning data from the user's mobile device, such as GPS, WiFi or Bluetooth beaconing, or inertial navigation systems.

The model can compare loaded resource information with real-time resolution pattern data to determine whether a direct, predicted, or proximity-based association is most appropriate. Example triggers for resource association can include the title of a WO or task, the room or area specified, proximity to other resources, or the GPS location of the user's mobile device. When a prompt is triggered based on these associations, the system can present the user with relevant information or actions tailored to the specific resource data gap and its context.

In some implementations, the process 200 includes operation 214, in which a triggering condition is set based on the location of a resource associated with a priority data gap, of a nearby user, or a relevant schedule. Triggering conditions can be configured to generate requests, initiate prompts, notifications, or automated actions when certain spatial, temporal, or contextual criteria are met. For example, a triggering condition can be set such that when a user carrying a mobile device enters a defined geofence or comes within a threshold distance (e.g., 10 meters) of a resource with a priority data gap, the system automatically prompts the user to address or collect data related to that gap. The location of the user can be determined using real-time positioning technologies such as GPS, WiFi triangulation, Bluetooth beaconing, or inertial navigation, and can be dynamically cross-referenced with the known or estimated location of the resource.

Additionally, triggering conditions can be set based on scheduled service times or maintenance windows. For instance, if a resource is scheduled for inspection, maintenance, or replacement within a certain time frame, and that resource is within a threshold distance of another resource with a priority data gap, the system can trigger a prompt or resolution pattern to address both resources during the same visit. Triggering conditions can also be configured to account for user roles, task types, or historical patterns, allowing for highly customizable and context-aware automation. These conditions can be defined through rules-based logic, user-configurable parameters, or adaptive machine learning models that optimize when and how prompts or actions are triggered, as further described with reference to operation 144 of process 100 in FIG. 1. including a service time of a resource that is within a threshold distance to the resource associated with the priority data gap.

The process 200 includes operation 212, which includes generating a request for a service to address the priority data gap. The operation 212 can include determining the fault type of the data gap and determining which corrective actions are appropriate to resolve it. Each corrective action is associated with specific requirements or tasks necessary to remediate the gap. The operation 212 can include evaluating a set of available services, each characterized by a defined set of capabilities, to determine which service or combination of services can fulfill the requirements of the corrective actions. The determination can be made by identifying an overlap between the requirements of the corrective actions and the capabilities offered by the services.

To determine the overlap, the operation 212 can include performing a matching process by comparing the requirements of the selected corrective action with the capabilities of one or more services to determine which satisfies all or a subset of the requirements. This can involve a direct comparison of requirement and capability descriptors, the use of semantic matching algorithms, or the application of rule-based logic. For example, if the corrective action requires “retrieving historical sensor data,” the operation 212 can include searching for services with the capability “data retrieval from backup” or “historical data access.” If a service's capabilities fully or partially match the requirements, an overlap is identified.

In those implementations where the service is at least partially performed by a user, the request can include a minimum level of expertise associated with a user role, a type of work that needs to be performed, and an urgency level of the corrective action. The capabilities of the service can include a user with a user role, types of work the user can perform, and an availability. The operation 212 can include weighing the availability of the user with the urgency level of the corrective action in determining if the user and the service are matched with the request.

In some implementations, the overlap can be quantified using a scoring or ranking mechanism, where services are evaluated based on the degree to which their capabilities align with the corrective action requirements. The operation 212 can include selecting the service with the highest degree of overlap or, if no single service meets all requirements, it can select a combination of services whose collective capabilities fulfill the corrective action. Once the overlap is established and a suitable service or set of services is identified, the operation 212 can include generating a request specifying the service(s), the nature of the data gap, and the corrective actions to be performed.

For example, if the corrective action for a missing data fault requires both “data retrieval” and “data integrity verification,” and Service A offers “data retrieval” while Service B offers both “data retrieval” and “data integrity verification,” the operation 212 can include identifying that Service B has a greater overlap with the corrective action requirements and selecting Service B to fulfill the request. Some implementations include operation 218, in which a user prompt is generated to collect, alter, or confirm data related to a resource data gap. Once resource gaps have been identified and associated with the dynamic-composite user location, the operation 218 can generate the prompt as an in-application alert or notification, or as a push notification to the user's mobile device. The prompt can be generated to include relevant information about the resource gap, such as the resource type, location, known attributes, and the specific data gap to be addressed. To enhance the relevance and clarity of the message, the operation 218 can use a fine-tuned large language model (e.g., GPT-4, BERT) to automatically compose the prompt based on the resource gap, available data, and context-specific templates. Alternatively, or in addition, the operation 218 can use predefined templates tailored to particular types of resource gaps, which are populated with the relevant details before being presented to the user. The prompt can also include actionable elements such as links or buttons that allow the user to navigate directly to relevant pages within the user interface, or to external systems such as a purchasing or maintenance management platform.

The prompt can be designed to facilitate immediate user action or confirmation by embedding UI elements for data entry, editing, or verification. For example, if the resource gap requires physical inspection, the prompt can appear as an overlay or pop-up within the current application, or redirect the user to a dedicated resource management tool. The user can be prompted to input missing data, update existing information, or confirm the accuracy of resource attributes. In addition to standard data entry fields, the prompt can enable the user to capture and upload images of the resource using the mobile device's integrated camera-such as photographing a resource nameplate or documenting the current condition of the resource. These images are then uploaded to the resource database and linked to the corresponding resource record.

The prompt can also instruct the user to perform physical tasks, such as affixing a QR code or other identification tag to the resource. This process ties the physical resource to its digital record in the database, enabling future maintenance teams to quickly scan the tag with a mobile device for rapid identification and data entry during inspections, testing, or maintenance activities. When multiple resource gaps are associated with the user's dynamic-composite location data, the system can prioritize the prompts to address the most critical gaps first. If the gaps are related-such as multiple gaps for a single resource or within a specific area—the system can consolidate them into a single, comprehensive prompt, streamlining the user's workflow and ensuring efficient resolution of all relevant data gaps.

In some implementations, operation 218 includes collecting human feedback to improve the underlying models described herein. For example, the prompt generated in operation 218 can include one or more user interface elements designed to capture explicit feedback from the user. The prompt can present a question such as, “Was this prompt helpful given your current location?” or “Is the identified asset data gap accurate or still relevant?” The user can respond via selectable options (e.g., “Yes,” “No,” or a rating scale), free-text input, or by flagging the prompt as irrelevant or inaccurate.

In addition to explicit feedback, operation 218 can include capturing implicit feedback signals. For example, if a user ignores a prompt, dismisses it without action, or takes an unusually long time to respond, these behaviors can be logged as implicit indicators of prompt relevance or accuracy. All such feedback-explicit and implicit—can be aggregated and associated with contextual metadata, such as the user's location, the specific asset gap, the time of day, and the user's role or task.

This feedback data can be used to train and refine the models described herein in operation 228. For example, supervised learning techniques can be employed, where the collected feedback serves as labeled data indicating the appropriateness or effectiveness of past prompts. Over time, the models can more accurately predict which prompts are likely to be helpful or actionable for users in specific contexts, thereby reducing unnecessary interruptions and improving overall system efficiency. In some implementations, the operation 218 can also use reinforcement learning, where positive user feedback reinforces the conditions under which similar prompts are generated in the future, while negative or ignored prompts lead to model adjustments that reduce similar prompts in comparable scenarios.

In some implementations, the process 200 includes operation 220, which includes generating a comprehensive list of resource data gaps that are relevant to the user's current context. The list may be tailored to the user based on relevance and responsibilities, or where work is planned to occur for a specific timeframe (e.g., day or week). This list is constructed by aggregating data gaps identified through previous operations, filtered and prioritized based on factors such as the user's current location, assigned tasks, resource criticality, and operational schedules. The system can use a combination of rules-based logic and machine learning models to determine which data gaps are most relevant for the user to address during their workflow. For example, if a maintenance technician enters a specific building, the system can query the resource database for all unresolved data gaps within that building or within a certain proximity to the technician's real-time location. The list can be further refined to include only those gaps that match the technician's role, skill set, type of work, assigned work orders, or scheduled maintenance activities. Operation 220 can feed into and enhance the content and relevance of the prompt generated in operation 218. For example, the resulting list of operation 220 can be included in the user prompt generated in operation 218, allowing the user to view, select, and address multiple data gaps efficiently during a single workflow session.

In some implementations, the process 200 includes operation 222, which includes presenting the user with various display options for interacting with the prompt or the list of data gaps. The display can be rendered in multiple formats depending on the user's device and workflow context. For example, on a desktop or tablet, the list of operation 220 can appear as a dashboard within a resource management tool, featuring sortable columns, filters, and expandable rows for detailed information. On a mobile device, the list can be presented as a scrollable notification panel or as individual push notifications for each high-priority data gap. The user interface can include interactive elements such as checkboxes for marking gaps as resolved, quick-action buttons for data entry or validation, and expandable sections for viewing additional resource details or historical data. The system can also support adaptive UI layouts that automatically adjust based on the user's device, screen size, and accessibility preferences, ensuring a seamless and efficient user experience across platforms.

These operations can be interconnected. For example, the display options in operation 222 can include the list of data gaps generated in operation 220 and the prompt content from operation 218. Specifically, after operation 220 generates and prioritizes a list of resource data gaps relevant to the user's context-using factors such as location, asset criticality, and operational schedules—this list can be passed as structured data (e.g., in JSON or database query results) to the user interface logic responsible for operation 222. The prompt content generated in operation 218, which can include specific instructions, recommended actions, or contextual information about each data gap, can also be included as metadata or embedded content within each list item. The user interface in operation 222 can render this information in a format optimized for the user's device and workflow, such as a dashboard, notification panel, or interactive checklist. For example, each entry in the displayed list can include not only the data gap's location and priority (from operation 220), but also the tailored prompt text and actionable elements (from operation 218), such as buttons for data entry, links to resource records, or image upload options. In some implementations, the prompt is displayed as a facility map including a current location of the user, a destination including a resource location, and a route connecting the current location with the destination.

In some implementations, the process 200 includes operation 224. Operation 224 includes generating and delivering communications or notifications to the user regarding outstanding resource data gaps. The system can automatically compose and send emails, SMS messages, or in-application notifications based on user preferences and organizational policies. These communications may include a summary of unresolved data gaps, prioritized action items, and direct links to the relevant sections of the resource management system for quick resolution. For example, an email notification may list all high-priority data gaps assigned to a technician for the day, along with links to the digital forms or image upload tools required to address each gap. The system may also support escalation workflows, where unresolved critical data gaps trigger notifications to supervisors or facility managers, ensuring accountability and timely resolution. The notifications generated in operation 224 can reference the same list of data gaps from operation 220 and the prompts from operation 218, and may include direct links to the user interface displays described in operation 222, thereby creating a closed-loop workflow that guides the user from notification to action and resolution.

In some implementations, the process 200 includes operation 224. Operation 226 includes receiving user input related to resource data, validating the entered data, and collecting user feedback. The user may provide new or updated resource information through embedded forms, dropdown menus, or image capture tools within the prompt. The system can perform real-time validation of the input data, such as checking for required fields, verifying data formats (e.g., serial numbers, dates), and cross-referencing with existing database records to prevent duplicates or inconsistencies. Advanced implementations may use machine learning models to detect anomalies or flag suspicious entries for further review. The user may also be prompted to provide qualitative feedback on the resource or the data collection process, such as reporting physical access issues or suggesting improvements to the workflow. Once validated, the user input is used to update the resource database, replacing invalid or outdated values and closing the corresponding data gap. This operation ensures that the resource management system maintains high data quality and accuracy, while also capturing valuable insights from frontline users.

The prompt can also include actionable elements such as links or buttons that allow the user to navigate directly to relevant pages within the user interface, or to external systems such as a purchasing or maintenance management platform. The process 200 includes operation 216, in which the priority data gap is remediated with service output. This can involve replacing the invalid value of the nonconforming attribute with the output of the service.

The method of remediation can depend on the fault type of the data gap. The remediation process can be fully automated, semi-automated, or manual, and can leverage rules, statistical models, artificial intelligence (AI), or direct user input.

In some implementations, remediation is accomplished through the use of a rules engine, which resolves data gaps based on predefined business logic or domain-specific rules. For example, if a resource's installation date is missing but the resource type and purchase order date are available, the operation 216 can include applying a rule to set the installation date as the purchase order date plus a standard lead time (e.g., fourteen days). In this example, the operation 216 can include retrieving the expected attributes and their recommended values from the resource reference, applying the rule, and updating the nonconforming attribute in the database with the computed value. To ensure traceability and compliance, the operation 216 can log the rule applied and the source data used in the remediation process.

Alternatively, the operation 216 can employ statistical models to impute missing or invalid values, particularly when historical or population-level data is available. For example, if the expected lifespan of a particular resource type is known and the installation date is missing, the operation 216 can estimate the installation date by subtracting the average age at failure from the current date, based on historical failure data. In this example, the operation 216 can include running a regression or other statistical analysis on the asset database, generating a predicted value, and updating the attribute in the record accordingly. The operation 216 can also assign a confidence score to the imputed value and flag low-confidence imputations for further review.

In more advanced implementations, the operation 216 can rely on machine learning or AI models to predict or infer the correct value for the nonconforming attribute. For example, a trained model such as a neural network or gradient boosting machine may take as input the asset's type, location, maintenance history, and other contextual features to predict the most likely value for the missing or invalid attribute, such as manufacturer, model number, or condition rating. The operation 216 can include invoking the AI model as a service, receiving the predicted value, and updating the attribute in the resource database. Over time, the model can be retrained using feedback from user corrections or new data (e.g., by following a process outlined in operation 228 above) thereby improving its accuracy.

In cases where automated remediation is not feasible or the confidence in automated outputs is low, the operation 216 can prompt a user to provide or confirm the correct value. The operation 216 can include generating a targeted prompt, as described in operation 218, and delivering it to the responsible user, including context such as asset location, type, and the specific data gap. The user can be presented with a form or data entry field to input the correct value, possibly with options to upload supporting documentation or images. The operation 216 can include validating the user input in real time, for example by performing format checks or cross-referencing with known values, before updating the database. User input can also be logged and used to improve future automated remediation models, creating a feedback loop.

Some implementations include a hybrid approach for operation 216, in which automated methods such as rules, statistical models, or AI generate a recommended value, which is then presented to the user for confirmation or correction

The remediation logic—whether based on rules, statistical models, or AI—can be encapsulated as microservices and invoked via RESTful APIs. Updates to asset attributes can be performed as atomic transactions to ensure data integrity. All changes, including the method of remediation and any associated confidence scores, can be logged with metadata such as timestamp and user ID for audit and compliance purposes.

Throughout the process 200, various systems can be used to generate prompts to address asset gaps. These can include work order systems, task systems, unit turns systems, site visit tools, and capital planning systems. The integration of these systems allows for comprehensive asset management across different aspects of facility operations.

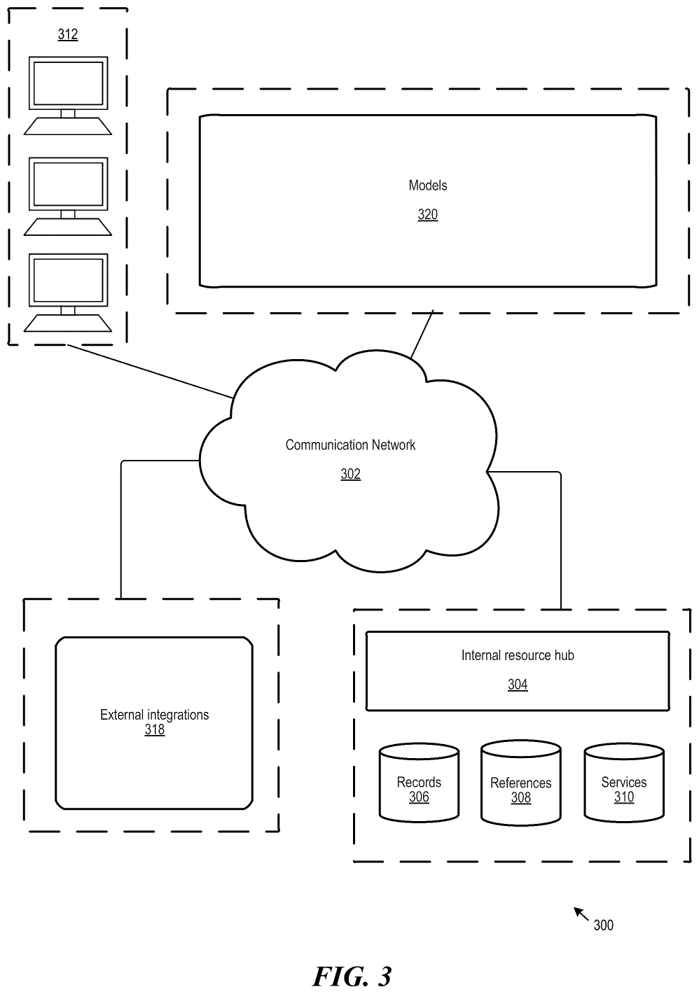

FIG. 3 illustrates a system diagram of a resource management framework 300, according to an implementation. The framework 300 comprises multiple interconnected layers arranged in a hierarchical structure. The framework 300 includes a communication network 302, a modelling system 320, a system of external integrations 318, an internal resource hub 304, and one or more access terminals 312 for connecting with the framework 300.

The communication network 302 provides connectivity, and can include secure protocols (such as TLS/SSL over TCP/IP) to enable real-time, bidirectional data exchange between all components of the framework 300. The communication network 302 supports both wired and wireless connections, ensuring redundancy and high availability.

Within the framework 300, the modelling system 320 can incorporate a suite of specialized models to enhance resource and resource management. The modelling system 320 is layered atop the resource hub, leveraging advanced analytics engines and machine learning frameworks (e.g., TensorFlow, PyTorch, or scikit-learn) to process and interpret data from the hub. This system can run predictive models, anomaly detection, and optimization algorithms, with results fed back into the resource hub for further action or reporting. The modelling system 320 can include a resource location predictor model. The modelling system 320 can include a resource data assessment model for evaluating the completeness and accuracy of resource records. The modelling system 320 can include a missing resource data model to identify gaps where critical resource information is absent. The modelling system 320 can include a duplicate resource data model to detect and flag redundant or overlapping resource entries. The modelling system 320 can include a stale resource data model to highlight records that have not been updated within a defined timeframe, ensuring data remains current. The modelling system 320 can include a crowdsourcing data model to leverage input from multiple users to validate and enrich resource data, increasing reliability through collective verification. The modelling system 320 can include an expected resources model to predict which resources should be present in a given location based on facility type, historical data, and operational requirements, supporting comprehensive audits. The modelling system 320 can include a resource gap prioritization model to rank identified resource gaps by urgency and impact, guiding users to address the most critical issues first. This can include a user location predictor model to estimate the real-time or likely location of users within a facility, enabling context-aware prompts and efficient workflow routing. The modelling system 320 can include a resource association model to map relationships between resources and locations, facilitating holistic resource management. The modelling system 320 can include a resource age/life model to calculate the age and projected useful life of resources, supporting maintenance and replacement planning. The modelling system 320 can include an equipment forecasting model to anticipate future equipment needs and potential failures based on usage patterns and historical performance. The modelling system 320 can include a capital planning recommendations model to synthesize data from all other models and generate actionable recommendations for capital investments, ensuring that planning decisions are data-driven and aligned with organizational priorities. The system of external integrations 318 provides standardized interfaces (such as OAuth2, SAML, or custom middleware) for seamless interoperability with third-party platforms, external data sources, and enterprise applications, ensuring the framework can ingest, process, and export data securely and efficiently. Access terminals 312—which can include web clients, mobile devices, or dedicated workstations-connect to the framework via secure endpoints, utilizing role-based access controls and multi-factor authentication to ensure only authorized users interact with the system. The system of external integrations 318 can include systems and databases for resident engagement, EMR and/or EHR, nurse calls, connected equipment, contractor systems (e.g., service provider tools), purchasing and/or procurement, including vendor product databases.

The internal resource hub 304 acts as a central repository, housing structured records 306 (such as relational database tables or distributed ledger entries), references 308 (including metadata, taxonomies, and ontologies for data normalization), and services 310 (such as RESTful APIs, microservices, and authentication modules). These elements are orchestrated through a service mesh or API gateway, which manages service discovery, load balancing, and secure access control. The records 306, references 308, and services 310 of the internal resource hub 304 can include the systems for resource compliance, equipment forecasting, capital planning, work orders (e.g., reactive maintenance), tasks (e.g., proactive maintenance), unit turns, and notifications and user messaging and/or communication (e.g., email, or SMS). The internal resource hub 304 can also include databases associated with such systems, including resource data (e.g., location, logs, inspections, testing, make, model, repair information, failure information, maintenance information, purchase information, purchase date, cost, resource age, usage, condition, images, video, audio, and/or warranty information), capital plan data, work order data, task data, user data, unit turn data, CMS and/or governance data, logs, budget data, work order schedule data, task schedule data, forecasting data, crowdsource data, invoice data, facility information, resource references (e.g., corporate configurations, and/or facility configurations), resource categories, resource data gaps, prompt templates, expected resource attributes (e.g., fields) and recommended attribute values.

The one or more access terminals 312 can include one or more computing devices or user profiles, configured for access and use by a variety of user roles (e.g., maintenance users, staff users, corporate users, regional users, or technician users). User roles can be assigned differing levels of access based on security permissions.

The framework 300 is modular, allowing it to accommodate a wide range of user roles, asset types, and external integrations.

The architecture is organized around a central communication network, which operates as the primary conduit for information exchange across all system components. User devices, representing the first major subsystem, include computing equipment used by on-site maintenance staff, facility managers, corporate or regional administrators, and third-party service provider technicians. These devices interface with the communication network to send and receive asset-related data, initiate maintenance tasks, and respond to compliance prompts as necessary.

The internal resource hub integrates embedded tools, interactive dashboards, and specialized modules that support the full lifecycle of resource management. Through its coupling to the communication network, the hub orchestrates workflows such as asset registration, service scheduling, performance monitoring, and regulatory compliance tracking. In addition, the internal resource hub is responsible for triggering context-sensitive prompts and reminders based on data generated by analytical models and real-time user activity.

A feature of the system is its suite of analytical and predictive models, each focused on a specific aspect of asset data integrity or operational optimization. These include, for example, asset data assessment, missing asset detection, duplicate data resolution, expected asset modeling, and stale data identification. The models also extend to advanced functionalities such as asset gap prioritization, user location prediction, and asset association analysis. Collectively, these models operate on data transmitted through the communication network, continuously analyzing, validating, and improving the quality of asset records.

In addition to internal components, the asset management system supports integration with a variety of external data sources and systems. These external integrations can encompass third-party procurement solutions, electronic medical or health record (EMR/EHR) platforms, and remote equipment monitoring tools. Each external system interfaces with the communication network, enabling bidirectional data exchange with the resource management platform and its analytical models. This ensures that relevant asset, procurement, and service information is consistently synchronized and available for real-time decision support.

The dynamic compliance process orchestrated by the system is enabled through ongoing collaboration between users, the resource management platform, analytical models, and external integrations, all interconnected via the communication network. This process is designed to automatically prompt users to verify, update, or supplement asset data as they interact with assets or perform their regular duties. As a result, the system continuously maintains up-to-date and accurate records, proactively identifies gaps or inconsistencies, and supports regulatory and operational compliance.

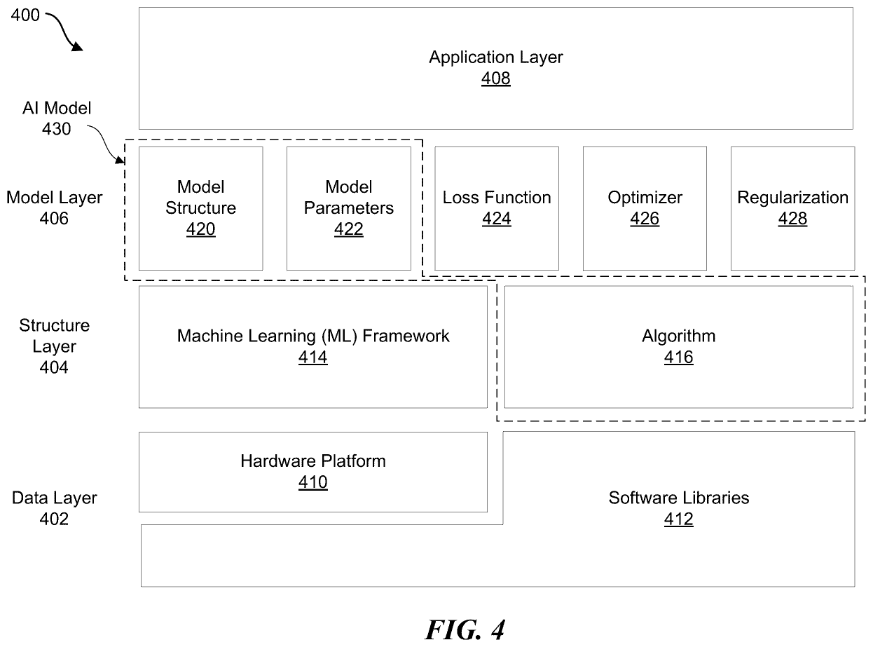

FIG. 4 illustrates a system architecture for an AI-driven resource management platform 400, in accordance with some aspects of the disclosure. One or more of the foregoing models described herein can be incorporated into the platform 400, individually or in combination. The platform 400 includes multiple interconnected layers arranged in a hierarchical structure.

A data layer 402 forms the foundation of the platform 400. The data layer 402 includes a hardware platform 410 and software libraries 412. The hardware platform 410 can provide the physical infrastructure for data processing and storage, including a non-transitory, computer-readable storage medium (e.g., memory), and at least one hardware processor. The software libraries 412 can include pre-built code modules and functions that support various operations within the platform 400.

Above the data layer 402 is a structure layer 404. The structure layer 404 contains a machine learning framework 414 and an algorithm module 416. The machine learning framework 414 can provide a set of tools and interfaces for implementing machine learning capabilities. The algorithm module 416 can contain specific algorithms and computational methods used for data analysis and processing.

A model layer 406 is positioned above the structure layer 404. The model layer 406 includes a model structure 420, model parameters 422, a loss function 424, an optimization module 426, and a regularization module 428. The model structure 420 can define the architecture and parameters of machine learning models used in the system. The model parameters 422 can represent the adjustable values within the model that are updated during training. The loss function 424 can measure the difference between the model's predictions and the actual values. The optimization module 426 can be responsible for adjusting the model parameters to minimize the loss function. The regularization module 428 can help prevent overfitting by adding constraints to the model.

The model layer 406 incorporates an AI model 430 that uses these components. In some cases, the AI model 430 can include an ensemble model comprising at least one of: a missing resource model, a duplicate resource model, a stale resource model, an anomalous resource model, and an unverified resource model. The ensemble model can be used to identify data gaps in asset records.

The platform 400 can use a distance metric to score similar attributes of assets. In some cases, these similar attributes can be selected after a comparison with a threshold similarity score. This approach can be used in conjunction with a crowdsourcing model trained to output expected values based on historical records of resources with similar attributes.

An application layer 408 sits at the top of the platform 400. The application layer 408 can interface with end-user applications and provide high-level functionalities that use the underlying layers.

The layers of the platform 400 are interconnected, allowing data and information to flow between the components. This interconnected structure enables the system to perform complex operations such as identifying and addressing data gaps in asset records.

In some cases, the platform 400 can include an expected resource model configured to output recommended values based on input including a log of records of similar resources with similar attributes. This model can be used to set recommended values for expected attributes of assets.

The platform 400 can categorize data gaps using a set of fault types. These fault types can include: missing data, duplicate data, stale data, anomalous data, and unverified data. By identifying specific fault types, the system can apply appropriate strategies for addressing each type of data gap.

Through the layered structure and specialized components, the platform 400 can enable efficient data processing, analysis, and decision-making for asset management within a facility or organization.

FIG. 5 illustrates a flowchart depicting a resolution pattern 500 for addressing data gaps. The resolution pattern begins when an asset breaks down 502. The asset break down 502 can lead to a work order (WO) creation 504, where maintenance tasks are initiated based on the identified assets. Alternatively, the WO creation 504 can be initiated by a base work order or a contracted service ticket 506 (e.g., submitted via a service-provider tool platform or a call in). The contracted service ticket can be provided from a discontiguous network that includes contracted service providers that perform work and maintenance for facilities.

Following work order creation 504, the resolution pattern moves to an asset association decision 508. This decision point can determine whether a work order is associated with a specific asset. If the asset association decision 508 is affirmative, the process proceeds to repair analysis 512. If negative, the process moves to asset association prompt 510. The asset association prompt 510 can request additional information to link the work order with an asset. Alternatively, work order trigger logic 514 can trigger the asset association prompt 510. The asset association prompt 510 feeds into a maintenance director (MD) decision 516. The maintenance decision 516 can determine whether to proceed with maintenance or replacement of an asset.

The maintenance decision 516 branches into one of three potential paths: (i) replace, (ii) service repair, or (iii) MD repair.

Replace leads to service options 518 and selecting an option 524. If selecting an option 524 is affirmative, the next event is service rendered or product received 526, completing WO and replacing asset in the resource management system 542, and situation resolved 544. If selecting an option 524 is negative, the next event in the resolution pattern 500 is MD procures replacement 528, and a determination if the new asset is in the resource management system 530. If answered in the negative, this leads to prompt cost tracking 540. If answered in the positive, this implementation of the resolution pattern 500 continues to completing WO and replacing the asset in the resource management system 542, then ending in situation resolved 544.

Service repair leads to a service provider (SP) repairing the unit 520, which continues to asset data validation 532, invoice spend tracking 534, which then ends in situation resolved 544.

MD repair proceeds to MD repairs unit 522 and a costs tracked decision 536. If the costs tracked decision 536 is negative, a prompt cost tracking 538 occurs, which is followed by another costs tracked decision 536. If affirmative, this path of this implementation of the resolution pattern 500 leads to situation resolved 544.

In some implementations, the resolution pattern 500 is initiated by a planned replacement 552, leading to capital forecast 554. This can continue through plan incorporation 556 and plan refinement 558 to replacement project 562. Alternatively, plan refinement 558 can come after an internal offering options presented 560. At internal decision 564, the resolution pattern 500 branches. If affirmative, the resolution pattern 500 moves to asset addition 566. If negative, the resolution pattern 500 goes to model prompt 568. Both paths lead to asset description 570, followed by asset retirement 572 and concluding with asset replacement 574.

As described herein, the resource management system can automatically create planned maintenance tasks and equipment logs in the work schedule based on inputs from external systems. These tasks can be associated with the work order creation 504 or the planned replacement 552 stages of the process.

In some cases, the resolution pattern 500 can include both proactive and reactive maintenance approaches. Proactive maintenance can involve linking a maintenance request to an existing task based on a triggering condition. Reactive maintenance can include creating a new work order and linking the request to the new work order based on the triggering condition.

The triggering condition can be determined based on a proximity between a first resource location of the request and a second resource location of the existing task or the new work order, a first scheduled time of the request and a second scheduled time of the existing task or the new work order, or both. This proximity-based triggering can help optimize maintenance scheduling and resource allocation.

The resolution pattern 500 can include a repair versus replace analysis. This analysis can provide recommendations based on historical asset data, considering factors such as past maintenance costs, asset age, and expected lifespan. The recommendations from this analysis can inform the maintenance decision 515 and subsequent actions in the process.

FIG. 6 illustrates a resolution pattern 600 for addressing a data gap created by a product purchased event. The resolution pattern 600 begins with a product purchased event 602, which can lead to different paths depending on the result of an internal purchase decision 604.

If affirmative, the resolution pattern 600 proceeds to operation 606, where a user can be prompted for an asset location. This can be followed by a decision at operation 612 to determine if the asset is replacing an existing one. If affirmative, operation 614 can retire the old asset, and operation 616 can automatically fill in asset information such as make, model, category, location, description, age, condition, purchased from, and warranty information.

If decision 604 is negative, the resolution pattern 600 moves to operation 608 where there is a customer purchase feed decision. If the decision is affirmative, the resolution pattern 600 proceeds to operation 610, where a user can be prompted for asset location, followed by a decision at operation 618 to check if the asset is replacing an existing one. If the decision at operation 618 is affirmative, operation 620 can retire the old asset. Operation 622 can have the user provide category, make and model, followed by operation 624 where location, category, description, age, and condition of the replacement asset can be automatically filled, and this path of this implementation of resolution pattern 600 can end in an inventory updated operation 648.

If the asset is not replacing an existing one from the decision at operation 618, operation 626 can have the user provide category, make and model. Operation 628 can automatically fill location, description, age, and condition. This path of this implementation of the resolution pattern 600 can conclude at operation 648 with the inventory updated.

In cases where the product was not purchased through customer purchase feed at operation 608, the resolution pattern 600 can proceed to operation 630 where a user can manually add the asset. At operation 632, the user can be prompted for asset location. A decision at operation 634 can check if the asset is replacing an existing one. If affirmative, operation 636 can retire the old asset, and operation 638 can have the user provide make and model. Operation 640 can automatically fill location, category, and description. Operation 646 can allow the user to provide age and condition. This path of this implementation of the resolution pattern 600 can conclude at operation 648 with the inventory updated.

If the asset is not replacing an existing one from the decision at operation 634, operation 642 can have the user provide category, make and model. Operation 644 can automatically fill location and description. Operation 646 can allow the user to provide age and condition. This path of this implementation of the resolution pattern 600 can conclude at operation 648 with the inventory updated.

In some cases, the resolution pattern 600 can include operations for setting expected attributes of a reference. These expected attributes can include required and prioritized resource fields, expected resource quantities, facility information, system rules, replacement strategy, and resource condition assessment frequency. One example of a reference for determining a data gap is the expected frequency of condition assessments for a given asset or asset type. This frequency can be defined by organizational preferences, regulatory requirements, or industry standards, and can vary depending on the criticality, usage, or risk profile of the asset. If the actual condition assessment data is older than an expected interval, the resolution pattern 600 can include an operation in which the resource management platform identifies this as a data gap and generates a prompt for a service to update this attribute. The reference can be generated according to financial needs, risk factors, industry standards, or user input. Industry standards can include asset-specific standards, such as recommended intervals for maintenance, inspections, and replacement, as well as best practices for data collection and recordkeeping for particular asset types.

The resolution pattern 600 can incorporate multiple paths for handling asset data based on purchase method and whether assets are being replaced or newly added. Each path can include steps for gathering necessary asset information through a combination of user input and automated data filling, ensuring comprehensive and accurate asset management.

FIG. 7 illustrates a flowchart depicting a resource audit resolution pattern 700. The resolution pattern 700 begins with an operation 702 where an asset audit proposal can be signed. This can lead to an operation 704 where a schedule can be determined with the location, followed by an operation 706 where the location can prepare users for the audit.

The resolution pattern 700 can continue to an operation 708 where an auditor can arrive and perform a site walk with an MD, followed by an operation 710 where the auditor can visit each in-scope asset. At an operation 712, a decision point can determine if all assets are collected. If affirmative, the process can move to an operation 714 to prompt the user for asset location.

At an operation 716, another decision point can check if all data is good. If affirmative, the resolution pattern 700 can move to an operation 720 to set community inventory expectations in the resource management system (e.g., the “hub”), followed by an operation 722 where the community can be trained on proper asset management. This branch of this implementation of the resolution pattern 700 can then proceed to an operation 724 where the audit can be completed.

If the decision at the operation 712 is negative, the resolution pattern 700 can move to an operation 726 to check if the asset is already in the hub. If affirmative, the resolution pattern 700 can move to an operation 728 to check if the asset is already tagged. If affirmative, an operation 730 can perform a scan of an asset tag. If negative at operation 728, the resolution pattern 700 can move to an operation 732 to tag the unit and associate with an existing asset. From operation 732 and operation 730, this path of this implementation of the resolution pattern 700 proceeds to operation 734 where existing asset details are confirmed, and operation 736 where the age and condition of the asset are updated. From operation 736, the resolution pattern 700 can move to an operation 746 to process the nameplate image, followed by an operation 748 to save the asset and move to the next one.

If negative at operation 726, the resolution pattern 700 can move to an operation 738 to tag the unit and scan. At an operation 740, a decision point can check if the nameplate is readable. If affirmative, an operation 742 can take a nameplate picture, followed by an operation 744 to fill in location, age, condition and other details. If negative, an operation 750 can fill in category, make, model, location, age, condition and other details.

From the operation 744, the resolution pattern 700 can move to an operation 746 to process the nameplate image, followed by an operation 748 to save the asset and move to the next one. The process can include multiple feedback loops to ensure comprehensive asset data collection and management.

In some cases, the resource management system can use machine learning models to adjust predictions of future gaps based on training feedback. This can involve retraining an ensemble model based on user feedback on prompt generation and data gap identification success rate. The ensemble model can be part of the AI-driven resource management platform 400, potentially implemented within the model layer 406 or the structure layer 404.

The machine learning framework 414 and the algorithm module 416 can be used to process the user feedback and update the model parameters. The optimization module 418 can fine-tune the model based on this feedback, improving the accuracy of future gap predictions and prompt generation.

This iterative process of collecting user feedback and retraining the model can enhance the system's ability to identify relevant data gaps and generate appropriate prompts during future asset audits. The improved model can lead to more efficient asset management processes, potentially reducing the time and effort required for subsequent audits.

FIG. 8 illustrates a flowchart depicting a resolution pattern 800 for preventive maintenance and event handling. The resolution pattern 800 can begin with a maximize life operation 802, and proceed to an operation 804 in which a platform can identify assets without a preventive maintenance (PM) plan. This identification process can involve analyzing existing asset data and determining which assets require regular maintenance.

In an operation 806, an asset can have a PM proposed to a user when a service option can be available. This proposal can be based on the asset's characteristics, maintenance history, and recommended maintenance schedules.

The resolution pattern 800 can then move to a decision operation 808 to determine if there can be an existing plan in the asset management system. From the operation 808, the resolution pattern 800 can follow multiple paths. One path can lead to an operation 810, where a user can choose an existing PM plan. This can lead to an operation 822 where the asset can be associated with the PM plan, followed by an operation 824 where the proposal can be in place.

Another path can lead to an operation 812, where a maintenance director (MD) can perform PM and choose an available PM plan. This can also lead to an operation 822 where the asset can be associated with the PM plan, followed by an operation 824 where the proposal can be in place.

From the operation 808, another path can lead to an operation 814, where a user can provide additional details including additional in-scope assets. This can connect to an operation 816 where a service representative can quote the PM program. A decision operation 818 can follow to determine whether to accept the quote. If not accepted, the resolution pattern 800 can return to the decision operation 808. If accepted, the resolution pattern 800 can move to an operation 820 where the PM contract can be rolled out, configured and started. This can also lead to an operation 822 where the asset can be associated with the PM plan, followed by an operation 824 where the proposal can be in place.

The resolution pattern 800 can include an alternative implementation beginning with an operation 832 for planned maintenance events. This can connect to an operation 834 where PM events can be scheduled per program. A decision operation 836 can determine if the event can be via a service. If affirmative, the process can move to an operation 838 where a vendor ticket can be created, followed by an operation 840 where the vendor can set a schedule and the customer can be notified.

A decision operation 842 can then determine if there is a schedule issue. If affirmative, an operation 844 can show the customer contacting the service to reschedule, leading to an operation 846 where the service can work with a service provider (SP) to reschedule, which returns to the operation 840. If negative at the operation 842, the resolution pattern 800 can move to an operation 848 where the vendor can arrive and complete work, followed by an operation 850 where the vendor can provide recommendations. This path continues to an operation 856 where work performed and associated time/costs can be tracked per asset, ending with an operation 858 marked as “Repeat.”

If negative at the operation 836, the resolution pattern 800 can move to an operation 852 where the MD can be presented with steps and guides on how to perform the maintenance, followed by an operation 854 where the MD can perform work and complete the task. This path also continues to the operation 856 where work performed and associated time/costs can be tracked per asset, leading to the operation 858 marked as “Repeat.”

In some cases, the resolution pattern 800 can use components of the AI-driven resource management platform 400 to enhance the preventive maintenance management process. The data layer 402 can store asset information and maintenance histories, while the structure layer 404 can provide algorithms for scheduling and prioritizing maintenance tasks. The model layer 406 can use machine learning techniques to predict maintenance needs and optimize PM schedules.

The machine learning framework 414 and the algorithm module 416 can be employed to analyze maintenance data and improve the efficiency of the PM process. The optimization module 426 can fine-tune maintenance schedules based on historical data and asset performance metrics.

In some cases, the resolution pattern 800 can integrate with other aspects of asset management, such as the asset breakdown 502 and work order creation 504 processes. The PM plans generated through this method can inform the planned replacement 552 and capital forecast 554 stages of the overall asset management process.

The resolution pattern 800 can provide a comprehensive approach to preventive maintenance management, incorporating both automated processes and user inputs to ensure efficient and effective maintenance of facility assets. By tracking work performed and associated costs, the method can contribute to improved asset lifecycle management and more accurate capital planning.

FIG. 9 illustrates a user interface for managing resource data. The interface can include a specialized workspace for managing room and asset data during the resident unit turnover process (a “unit turn”). As illustrated, the interface features a “Resident Room Details” section that displays building—and room-specific information (e.g., the area number, building designation, current operational status, e.g., “Turning,” and any relevant notes).

As illustrated in the example of FIG. 9, the central panel presents the “Best Practice Checklist,” an actionable list comprising inspection and maintenance items required for a compliant unit turn. Checklist items can cover critical facility elements, including walls, ceiling, paint, doors, windows, floors, plumbing, and electrical components. Each item can be paired with an interactive status indicator, e.g., checkboxes, dropdowns, and visual icons (e.g., green checkmarks for good, yellow warnings for repair, red symbols for replacement) to allow quick assessment, tracking, and signoff. Final checklist entries can require confirmation of deep cleaning or marketing team signoff, ensuring the entire turnover process is documented and completed according to policy.

The interface can include a dynamic location-based prompt 904. For example, as users interact with a unit or room, the system proactively detects gaps in asset data (e.g., missing purchase dates or condition ratings) and issues the prompt 904 to capture this information on the spot. For example, staff can be asked to enter an approximate asset purchase date, assign a condition rating, or upload a photo documenting current asset status. The prompt 904 is not confined to typical workflows and can appear when interacting with adjacent rooms or assets nearby.

FIG. 10 illustrates a user interface for a site visit tool displaying a checklist of standard items to assess during a facility inspection. The interface includes a header section with navigation elements and configuration options. Below the header is a “Site Visit” title indicating this is for engineering purposes only.

The user interface can be generated by the resource management system, in accordance with some aspects of the disclosure. The resource management system (e.g., running on a server) can cause the site visit user interface to be presented to a user via a computing device, for example. The user interface can generally be used by a user to manage workflow pertaining to a site a visit for a given facility (e.g., a visit to the facility to assess the assets maintained by the facility). As shown, the user interface includes a prompt 1004 that can be provided to the user to address a data gap identified by the resource management system. The prompt 1004 includes a message that is indicative of information about the data gap and information about a task for completion by the user to address the data gap.

Specifically, the message indicates there is a newly added asset (in this example, a boiler for an HVAC system) and that the information associated with the newly added asset in the asset database was autofilled based on purchase history by the resource management system. The message also requests that the user verifies that the autofilled asset details associated with the newly added asset to ensure that the autofilled asset details associated with the newly added asset are accurate. The prompt 1004 also includes a selectable user interface element (a “Verify Asset Details” button) that can be selected by the user via the user interface to launch an asset information user interface that the user can use to verify the autofilled asset details associated with the newly added boiler in the asset database and make any changes to the autofilled asset details associated with the newly added boiler in the asset database as necessary. The resource management system can generate the prompt 1004 based on the location associated with the site visit, the location of the user working on the site visit, and the location of the newly added boiler that is maintained in the asset database, for example.

FIG. 11 illustrates a second user interface for a site visit service displaying an input log for addressing data gaps. The user interface can include a web-based application, as illustrated, tailored for conducting structured asset audits and facilities assessments. The layout can be organized into a clear, grid-based structure with headers, interactive fields, and status indicators designed to streamline onsite data collection and gap remediation during inspections of major building systems (e.g., the Main Kitchen).

As illustrated, a navigation bar and breadcrumb trail can orient users within the platform and specific facility inspection. The input log can include a two-row, three-column photographic grid, as illustrated, where each cell displays a timestamped photograph of a facility area or asset (e.g., three-compartment sinks, ceiling lighting, coolers and freezers, tiled flooring, prep areas, and cooking equipment). Alongside each photo descriptive text annotations identifying the area or equipment can be displayed, noting conditions, repair or upgrade history, and referencing checklist status.

Each photo-annotation block can incorporate interactive controls for users to select standardized asset status indicators (e.g., Good, Repair, Replace, or Recommendation for Replacement) using icons or dropdowns. Users can add or view notes and are prompted to provide further asset or condition details as required. Fields collected include asset category, precise location, make/model, serial number, approximate age, purchase and installation price, warranty status, internal ID, and risk category. The interface can enforce data quality by flagging missing required information and prompting users to complete fields before moving forward.

Data collected through the grid and status fields can automatically update centralized asset records, linking photographs, notes, and condition assessments with the facility database for capital planning, compliance, or reporting. When urgent issues are identified (e.g., critical repairs or asset failures) the tool allows users to trigger task or work order creation directly from the interface. The interface can includes export options, context-sensitive banners for guidance and alerts, and workflow automation elements designed to ensure completeness and accuracy in on-site assessments.

FIG. 12 illustrates a user interface display showing details of a project. When a user accesses a project-such as a kitchen equipment installation-through the resource management platform, the interface presents a logically organized and visually structured workspace aimed at minimizing manual data entry and promoting the completeness and quality of asset information.

The left section of the interface, as illustrated, can consolidate summary information about the project. This includes the project title, a unique project identifier, assignment details specifying the responsible staff or contractor, and the room or area where the activity is scheduled. Within this section, editable text fields allow for easy modification of assignment information or location as project needs evolve. Additionally, a dedicated notes field enables users to record specifications or instructions relevant to the installation, such as details about plumbing requirements or equipment configuration. This left panel acts as the control center for project context, ensuring that all stakeholders have access to up-to-date, actionable details at a glance.

As illustrated in FIG. 12, the central portion of the user interface can include a vertically oriented, interactive project timeline is displayed. This visual timeline assembles project events in chronological order, associating each event-such as project creation, task assignment, data updates, and work completion—with distinct timestamps and brief coded descriptions. For example, the timeline can record when the project was created, when a status was changed from “open” to “in progress,” and which user completed a particular step. These entries can also highlight associated users to reinforce accountability, and status badges or color-coded icons are employed to illustrate project health, flag overdue actions, or elevate urgent issues. By providing a clear, intuitive audit trail, this section allows users to quickly retrace the project history and monitor progress in real time, which is vital for regulatory documentation and quality assurance.

Moving to the right-most section, the interface features a high-resolution image display, typically showing a photograph or schematic of the kitchen equipment or other asset under consideration. This image panel is designed for interactivity; users can enlarge the image for close examination, access supplementary visuals such as wiring diagrams or installation schematics, and upload new images to document work performed or annotate issues on-site. This capability not only supports remote collaboration and maintenance verification but also assists with compliance processes that require visual documentation or before/after evidence.

Beneath or adjacent to the summary section, the interface includes an asset fields table central to the compliance workflow. This dynamic table lists all asset attributes-such as serial number, asset ID, installation date, age, warranty status, condition, and related notes—in a matrix with columns labeled “Required” and “Optional.” Here, the system can automatically flag missing, out-of-date, or duplicate information; for example, critical rows lacking data are highlighted, and users are prompted to provide updates before project closure. The table is populated by integrations with procurement, inventory, and external equipment systems where possible, further reducing the manual burden on users.

To facilitate data completeness and prompt-driven remediation, the system employs a contextual notification and prompt engine. A prompt 1204 cam be presented directly within the user interface, on mobile devices, as dashboard messages, or via email and in-application notifications. The prompt 1204 can guide users to complete missing data, confirm ambiguous entries, or validate document uploads as they progress through their assigned tasks. For instance, if a technician attempts to finalize a work order for equipment with an incomplete asset record, the system can interrupt with the prompt 1204 requiring completion of the serial number or upload of a spec sheet.

Integrated document controls further support the collection and management of supporting materials. Users can attach and view specification sheets, compliance certificates, manuals, or inspection reports directly within the interface, with clear indicators showing the presence or absence of required documentation. The upload process supports common file formats and allows for both manual drag-and-drop and automated association with pre-existing database entries.

The interface design includes persistent navigation elements and workflow controls such as “CANCEL,” “SAVE,” “CREATE,” and escalation options. Breadcrumbs at the top of the page facilitate easy navigation between related modules or a return to the project overview. System-generated notifications appear as banners or pop-ups to alert users of requirement changes or status updates, ensuring that project stakeholders remain informed throughout the project lifecycle.

FIG. 13 illustrates an example resource information user interface. The example user interface can be generated by the resource management system in accordance with some aspects of the disclosure. The resource management system can cause the user interface to be presented to a user via a computing device, for example. The user interface can be used by various types of users to view and/or edit information associated with a particular asset associated with a given facility. In the example shown in FIG. 13, the user interface includes information about a boiler for an HVAC system installed in a facility. As shown in FIG. 13, the user interface includes a prompt 1304 that can be provided to the user to address a data gap identified by the resource management system.

The prompt 1304 includes a message that is indicative of information about the data gap and information about a task for completion by the user to address the data gap. Specifically, the message indicates that a nearby water heater needs to be assessed, and an asset condition and a risk category for the nearby water heater needs to be entered into the resource management system. The resource management system can generate the prompt 1304 based on the location of the user accessing the user interface and the location of the water heater associated with the data gap. The prompt 1304 also includes a selectable user interface element (an “Edit Asset” button) that can be selected by the user via the user interface to launch a user interface associated with the water heater, for example. The prompt 1304 can provide an example of a location-based prompt for a nearby asset that can be generated by the resource management system.

It should be noted that, as used herein, the term mechanism can encompass hardware, software, firmware, or any suitable combination thereof. It should be understood that the above described steps of the processes 100 and 200 can be executed or performed in any order or sequence not limited to the order and sequence shown and described in FIGS. 1 and 2. Also, some of the above steps of the processes 100 and 200 can be executed or performed substantially simultaneously where appropriate or in parallel to reduce latency and processing times.

Although the invention has been described and illustrated in the foregoing illustrative aspects, it is understood that the present disclosure has been made only by way of example, and that numerous changes in the details of implementation of the invention can be made without departing from the spirit and scope of the invention, which is limited only by the claims that follow. Features of the disclosed aspects can be combined and rearranged in various ways.

We claim:

1. A method for addressing data gaps in a fragmented data collection produced by a discontiguous network including one or more systems dispersed across digital and physical locations, comprising:
composing a record of known attributes describing a resource associated with the discontiguous network by matching common identification (ID) values from a plurality of data sources associated with the one or more systems;
retrieving a reference for the resource from the plurality of data sources including expected attributes populated with recommended values;
inputting actual values of the known attributes and the recommended values of the expected attributes from the reference into an ensemble model trained to generate a data gap set for the record,
wherein, for each data gap, the ensemble model determines a nonconforming attribute with an invalid value and a fault type;
inputting identified data gaps and the recommended values of the expected attributes into a data priority model trained to output scores for the data gaps,
wherein, for each identified data gap, the data priority model determines a priority score based on a resource impact score, a resource failure risk, and an anticipated gain from correction;
inputting the record, the nonconforming attribute, and the fault type for a priority data gap into a resource association model trained to output a resolution pattern,
wherein, for the priority data gap, the resource association model associates the resolution pattern with a triggering condition and one or more corrective actions to address the priority data gap; and
upon detection of an event satisfying the triggering condition, generating a request to address the priority data gap for a service, determined by an overlap between the one or more corrective actions and a set of capabilities of the service; and
remediating the priority data gap by replacing the invalid value of the nonconforming attribute with an output of the service.

2. The method of claim 1, wherein the service is partially performed by a user, wherein the output of the service replacing the invalid value includes a user input, and wherein generating the request further comprises displaying the request as a prompt in at least one of:
a user interface of a software tool,
a notification on a mobile device,
a dashboard of a resource management tool, and
a communication addressed to the user.

3. The method of claim 1, wherein the one or more corrective actions include entering, altering, or confirming the invalid value of the nonconforming attribute of the priority data gap,
wherein the service includes proactive maintenance or reactive maintenance, including a scheduled service time and a resource location,
wherein the proactive maintenance includes:
linking the request to an existing task based on the triggering condition, wherein the reactive maintenance includes:
creating a new work order; and
linking the request to the new work order based on the triggering condition, and wherein the triggering condition is determined based on a proximity between at least one of:
a first resource location of the request and a second resource location of the existing task or the new work order, and
a first scheduled time of the request and a second scheduled time of the existing task or the new work order.

4. The method of claim 1, wherein the ensemble model includes at least one of:
a missing resource model,
a duplicate resource model,
a stale resource model,
an anomalous resource model, and
an unverified resource model, and
wherein the fault type is selected from a set of fault types including:
missing data,
duplicate data,
stale data,
anomalous data, and
unverified data.

5. The method of claim 1, wherein the output of the service includes an inferred resource attribute value output by a resource inference model trained to output expected values based on historical records of resources with similar attributes, wherein the recommended values of the expected attributes are set by an expected resource model configured to output recommended values based on input including a log of records of similar resources with similar attributes, wherein the similar attributes are scored according to a distance metric and selected after a comparison with a threshold similarity score.

6. The method of claim 1, wherein the expected attributes of the reference include at least one of:
required and prioritized resource fields,
expected resource quantities,
facility information,
system rules, and
replacement strategy, and
wherein the reference is generated according to at least one of:
resource constraints,
risk factors,
industry standards, and
user input.

7. The method of claim 2, wherein the user input includes at least one of:
resource data,
resource data validation, and
user feedback; and
wherein the method further includes:
retraining the ensemble model based on the user feedback on prompt generation and data gap identification success rate.

8. The method of claim 2, wherein the prompt is displayed as a facility map including a current location of the user, a destination including a resource location, and a route connecting the current location with the destination.

9. A non-transitory, computer-readable storage medium comprising instructions recorded thereon, wherein the instructions, when executed by at least one data processor of a system, cause the system to:
compose a record of a resource associated with a network by matching common values from one or more data sources;
identify data gaps in the record using a first model to compare first values of first attributes from the record against a reference of the resource including second attributes and second values retrieved from the one or more data sources,
wherein, for each data gap, the first model determines a nonconforming attribute with an invalid value and a fault type;
associate a data gap with a resolution pattern by inputting the nonconforming attribute and the fault type into a second model,
wherein the resolution pattern includes a trigger; and
upon detection of an event satisfying the trigger, generate a request for a service to address the data gap,
wherein the service is configured to implement the resolution pattern.

10. The non-transitory, computer-readable storage medium of claim 9, wherein the service is partially performed by a user with a user input, and wherein generating the request further causes the system to display the request as a prompt in at least one of:
a user interface of a software tool,
a notification on a mobile device,
a dashboard of a resource management tool, and
a communication addressed to the user.

11. The non-transitory, computer-readable storage medium of claim 9, wherein the service includes proactive maintenance or reactive maintenance, including a scheduled service time and a resource location,
wherein the proactive maintenance further causes the system to:
link the request to an existing task based on the trigger,
wherein the reactive maintenance further causes the system to:
create a new work order; and
link the request to the new work order based on the trigger, and
wherein the trigger is determined based on a proximity between at least one of:
a first resource location of the request and a second resource location of the existing task or the new work order, and
a first scheduled time of the request and a second scheduled time of the existing task or the new work order.

12. The non-transitory, computer-readable storage medium of claim 9, wherein the first model includes at least one of:
a missing resource model,
a duplicate resource model,
a stale resource model,
an anomalous resource model, and
an unverified resource model, and
wherein the fault type is selected from a set of fault types including:
missing data,
duplicate data,
stale data,
anomalous data, and
unverified data.

13. The non-transitory, computer-readable storage medium of claim 9, wherein the service includes a resource inference model trained to output expected values based on historical records of resources with similar attributes,
wherein the second values of the second attributes are set by an expected resource model configured to output recommended values based on input including a log of records of similar resources with similar attributes,
wherein the similar attributes are scored according to a distance metric and selected after a comparison with a threshold similarity score.

14. The non-transitory, computer-readable storage medium of claim 9, wherein the second attributes of the reference include at least one of:
required and prioritized resource fields,
expected resource quantities,
facility information,
system rules, and
replacement strategy, and
wherein the reference is generated according to at least one of:
resource constraints,
risk factors,
industry standards, and
user input.

15. The non-transitory, computer-readable storage medium of claim 10, wherein the user input includes at least one of:
resource data,
resource data validation, and
user feedback, and
wherein the system is further caused to:
retrain the first model based on user feedback on prompt generation and data gap identification success rate.

16. A system comprising:
at least one hardware processor; and
at least one non-transitory memory storing instructions, which, when executed by the at least one hardware processor, cause the system to:
compose a record of a resource by matching IDs across one or more data sources;
identify a data gap in the record using a model to compare first values of first attributes from the record against a reference including second attributes and second values retrieved from the one or more data sources,
wherein the data gap includes a nonconforming attribute with an invalid value and a fault type; and
generate a request to resolve the data gap by correcting the invalid value of the nonconforming attribute according to the fault type.

17. The system of claim 16, wherein the request is partially performed by a user with a user input, and wherein generating the request further causes the system to display the request as a prompt in at least one of:
a user interface of a software tool,
a notification on a mobile device,
a dashboard of a resource management tool, and
a communication addressed to the user.

18. The system of claim 16, wherein the request includes proactive maintenance or reactive maintenance, including a scheduled service time and a resource location, wherein the proactive maintenance further causes the system to:
link the request to an existing task based on a proximity,
wherein the reactive maintenance further causes the system to:
create a new work order; and
link the request to the new work order based on the proximity, and wherein the proximity is calculated based on a difference between at least one of:
a first resource location of the request and a second resource location of the existing task or the new work order, and
a first scheduled time of the request and a second scheduled time of the existing task or the new work order.

19. The system of claim 16, wherein the model includes at least one of:
a missing resource model,
a duplicate resource model,
a stale resource model,
an anomalous resource model, and
an unverified resource model, and
wherein the fault type is selected from a set of fault types including:
missing data,
duplicate data,
stale data,
anomalous data, and
unverified data.

20. The system of claim 17, wherein the prompt is displayed as a facility map including a current location of the user, a destination including a resource location, and a route connecting the current location with the destination.
